(19) United States
(12) Patent Application Publication
(10) Pub. No.: US 2026/0319137 A1
(43) Pub. Date: Oct. 15, 2026

(54) ANTIREFLECTION FILM, LIQUID COMPOSITION, LIQUID COMPOSITION GROUP, AND METHOD FOR MANUFACTURING ANTIREFLECTION FILM

(71) Applicant: Nippon Sheet Glass Company, Limited, Tokyo (JP)

(72) Inventors: Hisao IMAI, Mie (JP); Hitomi MASUDA, Tokyo (JP)

(21) Appl. No.: 19/120,143

(22) PCT Filed: Sep. 27, 2023
(86) PCT No.: PCT/JP2023/035315

§ 371 Date: Apr. 10, 2025

(30) Foreign Application Priority Data
Oct. 11, 2022 (JP) 2022-163461

(51) Int. Cl. G02B 1/111

(52) U.S. Cl. CPC G02B 1/111

(57) ABSTRACT

An antireflection film 1a is a film provided on a substrate 3. The antireflection film 1a includes a first layer 11 and a second layer 12 in this order on its surface. The first layer 11 has a refractive index n_{L1} of 1.10 to 1.35 and a thickness t_{L1} of 80 nm to 150 nm. The second layer 12 has a refractive index n_{L2} of 1.30 to 1.55 and a thickness t_{L2} of 25 nm or less.

### TECHNICAL FIELD

The present invention relates to an antireflection film, a liquid composition, a liquid composition group, and a method for manufacturing an antireflection film.

### BACKGROUND ART

Techniques for preventing or reducing reflection of light from a surface of an article have been known.

For example, Patent Literature 1 describes a substrate having a surface on which a film is formed, the film including predetermined hollow spherical silica-based fine particles and a matrix for forming a coating film. In each of the silica-based fine particles, a cavity is formed inside a shell with pores, and a solvent or a gas is contained in the cavity. Since the silica-based fine particles have a low refractive index, the coating film also has a low refractive index, and the coating film exhibits excellent antireflection performance.

Patent Literature 2 describes an antireflection film that has a hard coat layer, a high-refractive-index layer, and a low-refractive-index layer in this order on a surface of an organic film. The high-refractive-index layer is a synthetic resin-based thin film including fine particles of a metal oxide such as ZrO₂. The synthetic resin is a UV-curable or electron-beam-curable synthetic resin.

Patent Literature 3 describes an antireflective laminate including a coating film formed by a single coating step using a coating composition including a binder resin in which low-refractive-index fine particles and medium- to high-refractive-index fine particles are dispersed. Silica fine particles treated with a fluorine-based compound are used as the low-refractive-index fine particles. As a result, due to the difference in specific gravity, the low-refractive-index fine particles are unevenly distributed in the upper or middle part of the coating film, and the medium- to high-refractive-index fine particles are unevenly distributed in the middle or lower part.

### CITATION LIST

### Patent Literature

Patent Literature 1: JP 2001-233611 A
Patent Literature 2: JP 2001-350001 A
Patent Literature 3: JP 2007-272132 A

### SUMMARY OF INVENTION

### Technical Problem

The techniques described in Patent Literatures 1 to 3 may need to be reconsidered from the viewpoint of antireflection performance. The present invention provides a novel antireflection film advantageous from the viewpoint of antireflection performance.

### Solution to Problem

The present invention provides an antireflection film to be provided on a substrate,
the antireflection film including a first layer and a second layer in this order from a surface of the antireflection film, wherein
the first layer has a refractive index n_{L1} of 1.10 to 1.35 and a thickness of 80 nm to 150 nm, and
the second layer has a refractive index n_{L2} of 1.30 to 1.55 and a thickness of 25 nm or less.

### Advantageous Effects of Invention

The above-described antireflection film is advantageous from the viewpoint of antireflection performance.

### BRIEF DESCRIPTION OF DRAWINGS

FIG. 1 is a cross-sectional view showing an example of an antireflection film according to the present invention.

FIG. 2 is a side view showing an example of an optical component including an antireflection film according to the present invention.

FIG. 3A is a cross-sectional view showing another example of an antireflection film according to the present invention.

FIG. 3B is a cross-sectional view showing yet another example of an antireflection film according to the present invention.

FIG. 3C is a cross-sectional view showing a state of first hollow fine particles in the antireflection film shown in FIG. 3A.

FIG. 3D is a cross-sectional view showing a state of first hollow fine particles in the antireflection film shown in FIG. 3A.

FIG. 4 is a cross-sectional view showing yet another example of an antireflection film according to the present invention.

FIG. 5 is a graph showing a reflection spectrum of an antireflection film according to Example 1.

FIG. 6 is a graph showing a reflection spectrum of an antireflection film according to Example 4.

FIG. 7 is a graph showing a reflection spectrum of an antireflection film according to Example 5.

FIG. 8 is a graph showing a reflection spectrum of the antireflection film according to Example 7.

FIG. 9 is a SEM image showing a cross-section of the antireflection film according to Example 1.

FIG. 10 is a SEM image showing a cross-section of the antireflection film according to Example 5.

### DESCRIPTION OF EMBODIMENTS

Embodiments of the present invention will be described below with reference to the accompanying drawings. The following description is for illustrating examples of the present invention, and the present invention is not limited to the embodiments described below.

An antireflection film is provided on a surface of an optical article, for example. Examples of optical articles to which the antireflection film can be provided include optical elements such as an optical filter, a lens, and a polarizer, various displays, glasses, and transparent shields. It is thought that an antireflection film to suppress reflection of light from a surface of an optical article can be formed by coating the optical article with materials having a predetermined refractive index. For example, antireflection films can play an important role in fields or applications such as optical elements like lenses and filters, windows and structural materials used in buildings, automobile windshields, and shields such as helmets and goggles. Antireflection films can suppress reflection of light from the surfaces of the articles or the substrates, and can also increase the amount of light transmitted through the articles or the substrates. Here, an antireflection film is composed of a single layer or a plurality of layers different from each other in materials, manufacture conditions or methods, and the antireflection film is provided on a surface of an article or a substrate to prevent or reduce reflection of light from the surface of the article or the substrate.

For example, a reflectance of one surface of a transparent dielectric composed of glass, a resin or the like is typically about 4 to 5%. Therefore, considering a reflection from the surface and a reflection from the rear face, the total reflectance may be 8 to 10% for a single sheet-shaped transparent dielectric. For example, an imaging device such as a camera usually has an optical system including a plurality of lenses composed of a transparent dielectric such as glass or a resin, so that the amount of reflection from the lens surface in the optical system is very large, which will greatly reduce the amount of light that reaches the light-receiving surface of the imaging element like CCD or CMOS.

Furthermore, the light reflected from the surface of the lens composed of a transparent dielectric such as glass or a resin reaches the light-receiving surface of the imaging element after repeatedly reflected or refracted at the internal structure of the imaging device or at other lens surfaces, and can cause an undesirable phenomenon such as ghost or flare. Therefore, it is important to form an antireflection film on a surface of an article or a substrate that functions, for example, to transmit or refract light and reduce reflection at the surface.

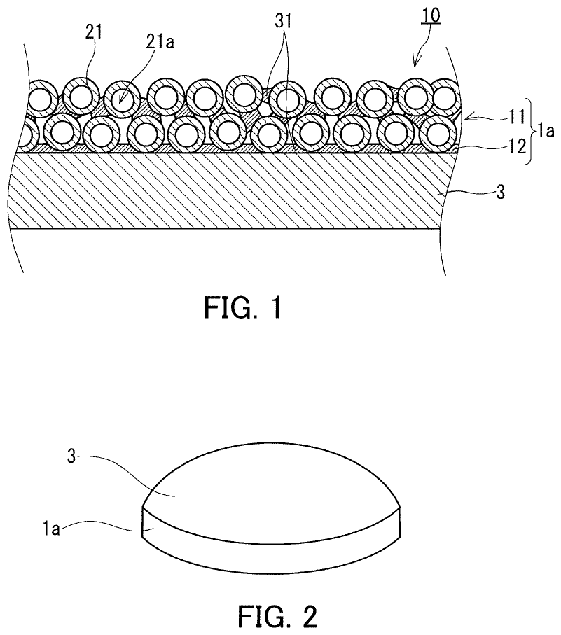

As shown in FIG. 1, an antireflection film 1a is a film to be provided on a substrate 3. The antireflection film 1a includes a first layer 11 and a second layer 12 in this order from the surface. The substrate 3 can be an article for transmitting and utilizing light within a required wavelength range. The substrate 3 can be a transparent dielectric. The second layer 12 is disposed between the first layer 11 and the substrate 3 in a thickness direction of the antireflection film 1a. The first layer 11 has a refractive index n_{L1} of 1.10 to 1.35 and a thickness t_{L1} of 80 nm to 150 nm. The second layer 12 has a refractive index n_{L2} of 1.30 to 1.55 and a thickness t_{L2} of 25 nm or less. With this configuration, the antireflection film 1a can exhibit high antireflection performance. The refractive index n_{L1} and the refractive index n_{L2} are the refractive indices at the D line (wavelength of 589.3 nm).

In the antireflection film 1a, for example, when light in a wavelength of 300 nm to 1200 nm is incident at an incident angle of 5⁰, the minimum reflectance rₘᵢₙ³⁰⁰⁻¹²⁰⁰ within a wavelength range of 300 nm to 1200 nm in the reflection spectrum, which shows a relationship between wavelength and reflectance for the wavelength, can be 1% or less. The reflectance rₘᵢₙ³⁰⁰⁻¹²⁰⁰ is preferably 0.5% or less, and more preferably 0.2% or less. Unless otherwise specified, the reflectance of an antireflection film or the like is regarded as a reflectance calculated from a reflection spectrum when light of a wavelength of 300 nm to 1200 nm is incident at an incident angle of 5°.

In the antireflection film 1a, the minimum reflectance rₘᵢₙ⁴⁰⁰⁻⁸⁰⁰ within a wavelength range of 400 nm to 800 nm is not limited to a specific value. The reflectance rₘᵢₙ⁴⁰⁰⁻⁸⁰⁰ is, for example, 0.5% or less. In this case, the antireflection film 1a is more likely to exhibit high antireflection performance. The reflectance rₘᵢₙ⁴⁰⁰⁻⁸⁰⁰ is preferably 0.2% or less.

In the antireflection film 1a, a range λ_{range/2.5}, in which the reflectance is 2.5% or less in the wavelength range of 300 nm to 1200 nm, is not limited to a specific value. The range λ_{range/2.5} is, for example, 400 nm or more. This makes it easier for the antireflection film 1a to exhibit high antireflection performance. The range λ_{range/2.5} may be 450 nm or more, or 500 nm or more. Unless otherwise specified, the wavelength and the wavelength range corresponding to the specified reflectance are also regarded as wavelengths obtained from the reflection spectrum.

In the antireflection film 1a, a range λ_{range/1.0}, in which the reflectance is 1.0% or less in the wavelength range of 300 nm to 1200 nm, is not limited to a specific value. The range λ_{range/1.0} is, for example, 250 nm or more. This makes it easier for the antireflection film 1a to exhibit high antireflection performance. The range λ_{range/1.0} may be 300 nm or more, may be 350 nm or more, or may be 400 nm or more.

As shown in FIG. 1, in the antireflection film 1a, the second layer 12 is formed in direct contact with the surface of the substrate 3, for example. In the thickness direction of the antireflection film 1a, another layer or another film may be disposed between the second layer 12 and the surface of the substrate 3.

For the antireflection film 1a, for example, a requirement n_{L1}<n_{L2} is satisfied. In this case, the antireflection film 1a is more likely to exhibit high antireflection performance.

The thickness t_{L2} of the second layer is preferably 15 nm or less, more preferably 10 nm or less, and even more preferably 5 nm or less. This makes it easier for the antireflection film 1a to exhibit high antireflection performance.

As shown in FIG. 1, the first layer 11 and the second layer 12 form a first multilayer structure 10 in the antireflection film 1a. The thickness t_{LL} of the first multilayer structure 10 is, for example, 100 nm to 160 nm. In this case, the antireflection film 1a is more likely to exhibit high antireflection performance. When the effective or representative refractive index n_{LD} at the D line (wavelength λ_{D} of 589.3 nm) and the thickness t_{LL} of the first multilayer structure 10 satisfy a requirement t_{LL}=λ_{D}/(4n_{LD}), the reflectance at the D line is minimized. Therefore, the thickness t_{LL} of 100 nm to 160 nm is advantageous from the viewpoint of high antireflection performance.

For the antireflection film 1a, the thickness t_{LL} and a wavelength λx [nm] may satisfy a requirement λx/6≤t_{LL}<λx/4, for example. In this case, the antireflection film 1a is advantageous in that the reflectance at the wavelength λx is likely to be decreased, and the wavelength range in which the reflectance is equal to or less than a predetermined value in the reflection spectrum can be increased. The wavelength λx is a specific wavelength within a wavelength range of 400 nm to 800 nm, for example. It may be the D line (wavelength of 589.3 nm), a wavelength representative of the wavelength range of the light to be used, a median wavelength of the wavelength range of the light to be used, or the most important wavelength in the wavelength range of the light to be used. The most important wavelength in the wavelength range of the light to be used may be the wavelength corresponding to the lowest reflectance within the predetermined wavelength range.

The optical thickness of the antireflection film may be adjusted to 1/4 of the predetermined wavelength λ when the refractive index of the substrate is n_{sb} and the refractive index of the antireflection film is n₁. In this case, when the absolute value of n_{sb}−n₁² is smaller, the reflectance is likely to be decreased at the wavelength λ corresponding to the refractive index. For this reason, in some cases, the effective refractive index for the antireflection film is desirably low from the viewpoint of reducing reflectance. When the antireflection film is required to have a low refractive index, it is advantageous for the antireflection film to include hollow fine particles.

As shown in FIG. 1, the first multilayer structure 10 includes, for example, first hollow fine particles 21 and a first binder 31. The first binder 31 binds the first hollow fine particles 21. With this configuration, the first layer 11 and the second layer 12 are likely to have desired refractive indices and desired thicknesses, and the antireflection film 1a is likely to exhibit high antireflection performance. In addition, since the first multilayer structure 10 includes the first hollow fine particles 21, as will be described later, the effective refractive index of the antireflection film 1a can be lowered, and improvements in mechanical strength such as peeling resistance and abrasion resistance, and improvements in weather resistance, such as moisture resistance, can be expected. In the present Description, the fine particles are particles having an average particle diameter of less than 1 μm.

Even if the material for forming the shells of the first hollow fine particles 21 has a predetermined refractive index, hollow portions 21a inside thereof can be regarded as being filled with air. Hence, when the first hollow fine particles 21 are included in the first multilayer structure 10, the effective refractive index is likely to be lowered. The first hollow fine particles 21 have a hollow balloon structure, for example. The refractive index of the first hollow fine particles 21 is, for example, 1.10 to 1.40, preferably 1.15 to 1.40, and more preferably 1.17 to 1.35. The refractive index of the first hollow fine particles 21 is not the refractive index of the material for forming the shells of the first hollow fine particles 21, but a substantial refractive index of the first hollow fine particles 21, taking account of the effect of the hollow portions 21a. The refractive index of the first hollow fine particles at a specific wavelength may be widely known, or it may be calculated by the effective medium approximation method using the Bruggemann equation, for example, after obtaining representative or average values for the approximate spherical size of the hollow fine particles, the material and the thickness of the shells of the hollow fine particles or the like.

The material for forming the shells of the first hollow fine particles 21 is not limited to a specific material. The material may be an inorganic material, an organic material, or an organic-inorganic hybrid material. Examples of the inorganic materials for forming the shells of the first hollow fine particles 21 include silicon oxide (silica) and magnesium fluoride. Examples of the organic materials for forming the shells of the first hollow fine particles 21 include polystyrene and polyethylene. These materials may be used alone or as a mixture of two or more thereof. From the viewpoint of facilitating manufacture of the hollow fine particles, the main component of the shells of the first hollow fine particles 21 is preferably silicon oxide. In the present Description, the main component is the component that is most abundant by mass.

The shape of the first hollow fine particles 21 is not limited to a specific shape. The first hollow fine particles 21 may be roughly spherical, irregularly shaped, or in a specific shape connected in a chain-like manner.

The average particle diameter Dₚ of the first hollow fine particles 21 is not limited to a specific value. The average particle diameter Dₚ is, for example, 5 to 200 nm. The average particle diameter Dₚ being 5 nm or more tends to reduce the cost for manufacturing the first hollow fine particles 21. In addition, the small volume of the hollow portion 21a can prevent insufficient decrease of the refractive index. Since the average particle diameter Dₚ is 200 nm or less, scattering of the light is suppressed even when light is incident on the first hollow fine particles 21, and the haze value of the antireflection film 1a is easily prevented from increasing. The size and shape of the fine particles can be confirmed and measured by observation using a scanning electron microscope (SEM), for example. The average particle diameter of the fine particles can be determined as follows. That is, a 100,000 times SEM image of a cross-section perpendicular to the main surface of an article or the like on which a film including fine particles is formed is acquired, and the fine particles are specified. The shape of the fine particles is approximated as a circle, and the diameter is measured, so that the arithmetic average value of the diameters of the fine particles in a predetermined area may be adopted. The area is, for example, within a 500 nm square area including all layers constituting the antireflection film. This method is convenient for determining the average particle diameter of fine particles included in a film or a layer that has already been solidified. In the case of approximating the shape of fine particles as circular in an SEM image, the smallest diameter circle that includes the area of each fine particle may be specified as the approximating circle.

The average particle diameter Dₚ is preferably 10 to 100 nm, and more preferably 30 to 80 nm.

The shells of the first hollow fine particles 21 may be crystalline, polycrystalline, or amorphous.

A thickness t_{S} of the shells of the first hollow fine particles 21 is not limited to a specific value. The thickness t_{S} is, for example, 1 to 50 nm. The thickness t_{S} of 1 nm or more tends to increase the mechanical strength of the shells and to maintain the hollow structure of the first hollow fine particles 21 in the desired state. The thickness t_{S} of 50 nm or less tends to facilitate manufacture of the first hollow fine particles 21. The thickness t_{S} of the shells of the hollow fine particles may be estimated from the relationship between the effective refractive index of the hollow fine particles, the volume of the approximated sphere of the hollow fine particles, the volume of the hollow portions or the like, by the effective medium approximation method using the Bruggemann equation.

In the first hollow fine particles 21, a ratio t_{S}/Dₚ of a thickness t_{S} of the shells to the average particle diameter Dₚ is not limited to a specific value. For example, the ratio t_{S}/Dₚ is 1/50 to 1/5.

The first hollow fine particles 21 may be hollow fine particles with modified surfaces. For example, fine particles pre-reacted with a compound having a metal component, an alkyl group, and an alkoxy group within a single molecule, or a hydrolysate of the compound, may be used. In this case, the compound may include a reactive functional group such as an amino group, an epoxy group, a methacrylate group, or a vinyl group. In addition, a compound referred to as a coupling agent may be used as such a compound. The coupling agent includes, for example, components such as Si, Ti, or Al. In the present Description, Si is regarded as a metal component.

In manufacture of the antireflection film 1a, the fine particles for the first hollow fine particles 21 may be provided as a powder or as a dispersion liquid of fine particles. The dispersion liquid of fine particles may be in the form of a colloid. For example, colloidal silica, which is a colloidal dispersion liquid of silicon oxide fine particles, may be used. Use of a dispersion liquid of fine particles allows the dispersion of the fine particles to be maintained stably, and the haze of the antireflection film 1a is likely to be lowered, whereby the antireflection film 1a is likely to have high transparency. The dispersant of the dispersion liquid may be an alcohol, a ketone, an ester, an ether, an aromatic hydrocarbon, or an amide. Examples of the alcohols include methanol, ethanol, isopropanol, butanol, and octanol. Examples of the ketones include acetone, methyl ethyl ketone, methyl isobutyl ketone, and cyclohexanone. Examples of the esters include ethyl acetate, butyl acetate, propylene glycol monomethyl ether acetate, and propylene glycol monoethyl ether acetate. Examples of the ethers include ethylene glycol monomethyl ether, propylene glycol monomethyl ether, propylene glycol monopropyl ether, and diethylene glycol monobutyl ether. Examples of the aromatic hydrocarbons include benzene, toluene, and xylene. And examples of the amides include dimethylformamide, dimethylacetamide, and N-methylpyrrolidone. Of these, methanol, isopropanol, butanol, methyl ethyl ketone, methyl isobutyl ketone, ethyl acetate, butyl acetate, propylene glycol monomethyl ether, toluene, and xylene are preferable as dispersants.

The first hollow fine particles 21 may be Thrulya 1110 (silicon oxide with average particle diameter (nominal) of approximately 50 nm, solid concentration of approximately 20 mass %) or Thrulya 4110 (silicon oxide with average particle diameter (nominal) of 50 nm to 60 nm, solid concentration of approximately 20 to 25 mass %), both of which are manufactured by JGC Catalysts and Chemicals Ltd. These are hollow fine particles with shells whose main component is silicon oxide.

The antireflection film 1a includes a binder such as the first binder 31. The binder allows the fine particles included in the antireflection film 1a to bind to each other and to bind to the substrate, an undercoat layer or the like. A binder is inherently a material to be used to bind particles, pigments, substrates or the like within the layers. In the present Description, for example, a component that solidifies within layers free of pigments or particles so as to form a uniform structure is also regarded as a binder.

The binder material included in the antireflection film 1a is not limited to a specific material. The binder can be, for example, a liquid compound or composition whose precursor is curable by heating or irradiation with electromagnetic waves such as light. If a binder precursor is a liquid, the precursor of the antireflection film 1a can be easily prepared in manufacturing the antireflection film 1a, which may facilitate addition of the fine particles, dispersion of the fine particles, colloidization of the fine particles, dissolution of the fine particles, or the like.

The binder precursor may be, for example, a monomer or an oligomer that has a polymerizable unsaturated group, such as an acrylic group, a vinyl group, or an allyl group, in its molecule. The binder precursor may be a compound that has at least one polymerizable unsaturated group in a single molecule. The binder precursors are not limited to specific compounds. Examples of the binder precursors include 2-hydroxyethyl (meth)acrylate, 2-hydroxypropyl (meth)acrylate, 2-hydroxybutyl (meth)acrylate, 2-hydroxy-3-phenoxypropyl (meth)acrylate, neopentyl glycol mono(meth)acrylate, trimethylolpropane di(meth)acrylate, trimethylolethane di(meth)acrylate, pentaerythritol tri(meth)acrylate, and dipentaerythritol penta(meth)acrylate. The binder precursor may be a compound obtained by an addition reaction of a (meth)acrylic acid with a glycidyl-group-containing compound such as an alkyl glycidyl ether, an allyl glycidyl ether, or glycidyl (meth)acrylate. The binder precursor may be a compound including a polymerizable functional group, and may be a precursor of a silicone resin, an epoxy resin, a phenoxy resin, a novolak resin, a silicone acrylate resin, a melamine resin, a phenol resin, a polyimide resin, or a urethane resin.

The binder precursor may include a metal alkoxide or its hydrolysate having a metal component and an alkoxy group as shown in the following Formula (A). In Formula (A), R^{x} and R^{y} are functional groups each including at least a carbon atom, M is a metal atom, and n and m are the numbers of functional groups substantially included in a single molecule.

R^{x}ₘM(OR^{y})ₙ Formula (A)

The metal component is selected from the group consisting of Si, Ti, Nb, Zr, and Al, for example. The binder precursor can preferably include an alkoxysilane having Si and an alkoxy group, as represented by the following Formula (B), its hydrolysate, or a polysilane polymerized from its hydrolysate. R¹ and R² are identical or different functional groups each including a carbon atom and a hydrogen atom, and n is an integer from 1 to 4.

R¹₄₋ₙSi(OR²)ₙ Formula (B)

The alkoxysilane undergoes hydrolysis in the presence of water to produce silanol groups (—Si—OH), and further condensation polymerization of the silanol groups causes formation of siloxane bonds (—O—Si—O—) between a plurality of molecules. This increases the molecular weight and forms a polymer, whereby a binder including silica or silsesquioxane can be obtained relatively easily. Silica is produced by a reaction of a tetrafunctional alkoxysilane that satisfies n=4 in Formula (B). Silsesquioxane is produced by a reaction of a trifunctional alkoxysilane that satisfies n=3 in Formula (B).

Silica is the main component of glass. Ordinary glass requires a process of melting silica sand at extremely high temperatures. However, solidification of a composition including silica with an alkoxysilane is advantageous in that it can be achieved at low temperatures. In addition, a binder that includes an alkoxysilane as a part of the raw materials can include silica or the like, and the binder is advantageous from the viewpoint of durability. In addition, a binder that includes an alkoxysilane as a part of the raw materials is likely to have desired properties, for example, from the viewpoint of affinity with the fine particles or formation of hydrogen bonds with the fine particles even when the binder encloses fine particles that includes a silicon oxide such as silica as its main component, and thus, enhancement of the binding strength between the fine particles will be expected. In addition, the difference in refractive indices between the binder and the fine particles is likely to be decreased, and the transparency of the layer or the film including the binder and the fine particles is likely to be improved.

The alkoxysilanes included in the binder precursors are not limited to specific alkoxysilanes. Examples of alkoxysilanes include tetramethoxysilane, tetraethoxysilane, tetra(i-propoxy)silane, trimethoxysilane, triethoxysilane, methyl trimethoxysilane, methyl triethoxysilane, ethyl trimethoxysilane, ethyl triethoxysilane, propyl trimethoxysilane, propyl triethoxysilane, isobutyl triethoxysilane, methyl tri-iso-propoxysilane, ethyl tri-iso-propoxysilane, dimethoxysilane, diethoxysilane, methyl dimethoxysilane, methyl diethoxysilane, dimethyl dimethoxysilane, dimethyl diethoxysilane, diethyl dimethoxysilane, diethyl diethoxysilane, diethyl di(i-propoxy) silane, methyl ethyl dimethoxysilane, methyl ethyl diethoxysilane, methyl ethyl di(i-propoxy) silane, methyl propyl dimethoxysilane, methyl propyl diethoxysilane, methyl propyl di(i-propoxy) silane, methoxysilane, ethoxysilane, methyl methoxysilane, methyl ethoxysilane, dimethyl methoxysilane, dimethyl ethoxysilane, trimethyl methoxysilane, trimethyl ethoxysilane, trimethyl (i-propoxy) silane, triethyl methoxysilane, triethyl ethoxysilane, triethyl (i-propoxy) silane, tripropyl methoxysilane, tripropyl ethoxysilane, tripropyl (i-propoxy) silane, methyl diethyl methoxysilane, methyl diethyl ethoxysilane, methyl diethyl (i-propoxy) silane, methyl dipropyl methoxysilane, methyl dipropyl ethoxysilane, methyl dipropyl (i-propoxy) silane, ethyl dimethyl ethoxysilane, ethyl dimethyl (i-propoxy) silane, ethyl dipropyl methoxysilane, ethyl dipropyl ethoxysilane, ethyl dipropyl (i-propoxy) silane, propyl dimethyl methoxysilane, propyl dimethyl ethoxysilane, propyl dimethyl (i-propoxy) silane, propyl diethyl methoxysilane, propyl diethyl ethoxysilane, propyl diethyl (i-propoxy) silane, bis(trimethoxysilyl)methane, bis(triethoxysilyl)methane, bis(trimethoxysilyl)ethane, bis(triethoxysilyl)ethane, 1,3-bis(trimethoxysilyl)propane, 1,3-bis(triethoxysilyl)propane, hexamethoxydisiloxane, hexaethoxydisiloxane, 3-chloropropyltrimethoxysilane, 3-chloropropyl triethoxysilane, 3-hydroxypropyl triethoxysilane, 3-mercaptopropyl trimethoxysilane, 3-mercaptopropyl triethoxysilane, trifluoropropyl trimethoxysilane, trifluoropropyl triethoxysilane, tetraacetoxysilane, tetrakis(trichloroacetoxy)silane, tetrakis(trifluoroacetoxy)silane, triacetoxysilane, tris(trichloroacetoxy)silane, tris(trifluoroacetoxy)silane, methyl triacetoxysilane, methyl tris(trichloroacetoxy)silane, methyl tris(trifluoroacetoxy)silane, methyl diacetoxysilane, methyl bis(trichloroacetoxy)silane, methyl bis(trifluoroacetoxy)silane, dimethyl bis(trichloroacetoxy)silane, dimethyl bis(trifluoroacetoxy)silane, methyl acetoxysilane, methyl (trichloroacetoxy)silane, methyl (trifluoroacetoxy)silane, dimethyl acetoxysilane, dimethyl (trichloroacetoxy)silane, dimethyl (trifluoroacetoxy)silane, trimethyl acetoxysilane, trimethyl (trichloroacetoxy)silane, trimethyl (trifluoroacetoxy)silane, tetrachlorosilane, tetrabromosilane, tetrafluorosilane, trichlorosilane, tribromosilane, trifluorosilane, methyl trichlorosilane, methyl tribromosilane, methyl trifluorosilane, methyl dichlorosilane, methyl dibromosilane, methyl difluorosilane, dimethyl dichlorosilane, dimethyl dibromosilane, dimethyl difluorosilane, methyl chlorosilane, methyl bromosilane, methyl fluorosilane, dimethyl chlorosilane, dimethyl bromosilane, dimethyl fluorosilane, trimethyl chlorosilane, trimethyl bromosilane, and trimethyl fluorosilane. The binder or the binder precursor may be a hydrolysate of the alkoxysilane having a silanol group, or a compound in which the hydrolysate of the alkoxysilane is polymerized by a siloxane bond.

The binder or the binder precursor may include different types of alkoxysilanes, hydrolysates of different types of alkoxysilanes, or polymers of hydrolysates of different types of alkoxysilanes.

An alkoxysilane included in the binder precursor may have, in addition to the alkoxy group, a reactive functional group such as an acryloyl group or an epoxy group, or a polymerizable unsaturated group, within a single molecule. Examples of such alkoxysilanes include 3-glycidoxypropyl trimethoxysilane, 3-glycidoxypropyl triethoxysilane, 3-acryloxypropyl trimethoxysilane, 3-acryloxypropyl triethoxysilane, 3-methacryloxypropyl trimethoxysilane, 3-methacryloxypropyl triethoxysilane, 3-acryloxy triacetoxysilane, 3-acryloxypropyl tris(trichloroacetoxy)silane, 3-acryloxypropyl tris(trifluoroacetoxy)silane, 3-methacryloxypropyl triacetoxysilane, 3-methacryloxypropyl tris(trichloroacetoxy)silane, 3-methacryloxypropyl tris(trifluoroacetoxy)silane, 3-glycidoxypropyl triacetoxysilane, 3-glycidoxypropyl tris(trichloroacetoxy)silane, 3-glycidoxypropyl tris(trifluoroacetoxy)silane, 3-acryloxypropyl trichlorosilane, 3-acryloxypropyl tribromosilane, 3-acryloxypropyl trifluorosilane, 3-methacryloxypropyl trichlorosilane, 3-methacryloxypropyl tribromosilane, 3-methacryloxypropyl trifluorosilane, 3-glycidoxypropyl trichlorosilane, 3-glycidoxypropyl tribromosilane, and 3-glycidoxypropyl trifluorosilane.

The first binder 31 includes at least one selected from the group consisting of, for example, an alkoxysilane, a hydrolysate of an alkoxysilane, and a polymer of a hydrolysate of an alkoxysilane. This makes it easier for the antireflection film 1a to exhibit high antireflection performance.

The second layer 12 includes, for example, the first binder 31 present near a surface of the substrate 3 and a part of the shells of the first hollow fine particles 21 present near the surface of the substrate 3. A part of the first hollow fine particles 21 present near the surface of the substrate 3 may be in contact with the surface of the substrate 3. Therefore, the second layer 12 is almost completely filled with a solid and includes almost no hollow portions or void portions to include air. For example, in the case where the main component for forming the shells of the first hollow fine particles 21 is silicon oxide, and the first binder 31 includes a hydrolysate of an alkoxysilane or a polymer of the hydrolysate, the second layer 12 can be configured with a material whose main component is silicon oxide. In this case, the refractive index of the second layer 12 will be close to the refractive index of silicon oxide or a modified form of silicon oxide. On the other hand, the first layer 11 includes the shells of the first hollow fine particles 21, the hollow portions 21a of the first hollow fine particle 21, and the voids between the first hollow fine particles 21. In this way, the first layer 11 includes air having a refractive index of approximately 1. As a result, the first layer 11 and the second layer 12 are likely to have desired refractive indices and desired thicknesses, and a requirement n_{L1}<n_{L2} is likely to be satisfied. In the first layer 11, as the volume occupied by the air is larger, the refractive index n_{L1} of the first layer 11 tends to be smaller, and a requirement n_{L1}<n_{L2} is more likely to be satisfied.

The second layer 12 has a thickness, for example, smaller than the average particle diameter Dₚ of the first hollow fine particles 21. Furthermore, the second layer 12 may have a thickness smaller than the thickness t_{S} of the shells.

The substrate 3 is not limited to a specific substrate, as long as it has an antireflection film 1a provided on its surface. The optical properties of the antireflection film 1a may be designed to take into account the optical properties of the substrate 3.

The substrate 3 is, for example, a substrate to be used in image display devices such as displays. The substrate 3 may be an optical element such as an optical filter, a lens, or a diffraction element. The optical filter can cause a predetermined physical change in incident light and can exhibit a function of transmission, reflection, absorption, diffusion, or a combination thereof. The lens can cause conversion or diversion of light by refraction of light. The diffraction element can exhibit a predetermined function by diffracting light with irregularities on its surface or in its interior.

As shown in FIG. 1, the substrate 3 is, for example, shaped as a flat plate. The substrate 3 may have a curved plane on the entire or a part of its surface, or it may have a smooth surface with irregularities. For example, in the case where the substrate 3 is a lens, the surface of the substrate 3 may include a curved plane. In addition, the substrate 3 may be a substrate for a windshield of a helmet or a display screen of a head-mounted display. In this case, the entire substrate 3 is gently curved. In the case where the substrate 3 is a diffraction element, it can have a surface with irregularities of a size corresponding to the wavelength of the light to be diffracted or a size close to the wavelength.

FIG. 2 is a side view showing an example of an optical component with a substrate 3 and an antireflection film 1a. As shown in FIG. 2, the substrate 3 may be a lens like a convex lens.

The material of the substrate 3 is not limited to a specific material. The substrate 3 is, for example, a material that can exhibit functions for an optical article.

The substrate 3 has, for example, high transparency and includes glass or a resin. The glass is not limited to any specific glass. Examples of the glass include soda lime glass, borosilicate glass, aluminosilicate glass, (synthetic) quartz, lead glass, barium glass, phosphate glass, fluoro phosphate glass, and lanthanum glass. The glass may be produced using a sol-gel method. In this case, a structure having a size suitable for a wavelength of light can be formed easily. The raw material for glass to be used in the sol-gel method is a compound that has a metal and an alkoxy group.

The resin included in the substrate 3 is not limited to a specific resin. Examples of the resins include an acrylic (methacrylic) resin, a styrene-based resin, a polycarbonate resin, a polyolefin-based resin, an epoxy resin, a polyethylene-based resin, a polypropylene-based resin, an ABS resin, a polyamide resin, a polyacetal resin, and a polyethylene terephthalate resin.

The refractive index n_{SB} of the substrate 3 at the D line is 1.20 to 2.50, for example, which may be 1.30 to 2.30, or may be 1.35 to 2.00.

The antireflection film 1a or the layers included in the antireflection film 1a may be produced by solidifying a predetermined liquid composition, for example.

The liquid composition includes a binder precursor and, if necessary, fine particles. The liquid composition may further include organic polymers, examples of which may include polyethers such as polyethylene glycol, polypropylene glycol, and polytetramethylene glycol, or a polyisocyanate compound. As a result, these organic polymers function as cross-linking agents when curing the liquid composition, making it possible to improve the mechanical properties of the antireflection film 1a, such as hardness and scratch resistance, as well as light resistance or weather resistance.

The liquid composition may further include a polymerization initiator. A polymerization initiator is selected from known polymerization initiators, such as a thermal radical generator, a photo-radical generator, a thermal acid generator, or a photo-acid generator, to correspond to the pattern of reaction of the polymerizable functional group or the polymerizable monomer as described above.

In the case where the binder precursor partially includes an alkoxysilane or a hydrolysate thereof, the liquid composition may also include water to promote hydrolysis, acids (acid catalysts) or alkalis (alkali catalysts) to function as catalysts. Examples of the acids (acid catalysts) include hydrochloric acid, sulfuric acid, nitric acid, phosphoric acid, boric acid, formic acid, and acetic acid; examples of the alkali catalysts include ammonia, trialkylamine, sodium hydroxide, potassium hydroxide, choline, and tetraalkylammonium hydroxide. Of these, formic acid and acetic acid are organic acids capable of dissolving alkoxysilanes. In addition, these acids have the following properties, which make them desirable as acid catalysts: they are substantially free of halogens, have a low acid dissociation constant (pKa) (for formic acid, pKa=3.7; for acetic acid, pKa=4.7), and they are strong acids. In the case where the acetic acid and the formic acid are used as acid catalysts, silanol groups are formed even when there is little or no water in the system, so the polysilane structure can be formed without undergoing hydrolysis. From this viewpoint, the use of formic acid and acetic acid is desirable. In addition, the formic acid having a fairly simple structure in comparison with the other organic acids easily exhibits the desired properties as an acid catalyst.

The liquid composition may be prepared, for example, by adding the catalyst dropwise to a liquid including alkoxysilane while stirring the liquid. This can prevent the reaction from progressing too rapidly as a result of addition of a large amount of the catalyst compound at once, and thus, an unbalanced reaction is unlikely to occur.

The liquid composition may include a solvent. The solvent contributes, for example, to dispersion of fine particles or the like, and thus, the liquid composition is likely to have the desired viscosity in the process of manufacturing the antireflection film 1a. In addition, the work of coating the liquid composition or the quality of the coating film is likely to be adjusted to the desired level. The metal alkoxide compounds such as an alkoxysilane that is the raw material of the binder 31 may be difficult to dissolve in the water immediately after mixing, the water being required for hydrolysis. For this reason, the liquid composition may include an organic solvent that is compatible with both the metal alkoxide and the water. The solvent included in the liquid composition is not limited to a specific solvent. The solvents included in the liquid composition may include alcohols, ketones, esters, ethers, aromatic hydrocarbons, or amides. Examples of the alcohols include methanol, ethanol, isopropanol, butanol, octanol, 1-methoxy-2-propanol, and 3-methoxy-3-methyl-1-butanol. Examples of the ketones include acetone, methyl ethyl ketone, methyl isobutyl ketone, and cyclohexanone. Examples of the esters include ethyl acetate, butyl acetate, propylene glycol monomethyl ether acetate, and propylene glycol monoethyl ether acetate. Examples of the ethers include ethylene glycol monomethyl ether, propylene glycol monomethyl ether, propylene glycol monopropyl ether, and diethylene glycol monobutyl ether. Examples of the aromatic hydrocarbons include benzene, toluene, and xylene. Examples of the amides include dimethylformamide, dimethylacetamide, and N-methylpyrrolidone. Organic acids such as an acetic acid and a formic acid may also be used as a solvent in the preparation of the liquid composition. Of these, preferably, at least one selected from the group consisting of methanol, isopropanol, butanol, 1-methoxy-2-propanol, 3-methoxy-3-methyl-1-butanol, methyl ethyl ketone, methyl isobutyl ketone, ethyl acetate, butyl acetate, propylene glycol monomethyl ether, toluene, and xylene can be used as a solvent. These solvents may be used alone or in a mixture of two or more thereof.

The liquid composition may include a compound having a hydrophilicity and a hydrophobicity, such as a surfactant and a silane coupling agent, for the purpose of preventing agglomeration of fine particles.

The liquid composition may be prepared by selecting and mixing fine particles, a binder precursor, a solvent, a catalyst, and the above-mentioned compound while adjusting the composition ratio of each component according to known methods and requirements, and allowing some of the compounds to react as necessary.

In the liquid composition as a precursor of the first multilayer structure 10 of the antireflection film 1a, the ratio of the mass of the solid content of the first hollow fine particles 21 to the mass of the solid content of the liquid composition is not limited to a specific value. For example, the ratio is 80% to 99.5%. With this configuration, the first layer 11 and the second layer 12 are likely to have desired refractive indices and desired thicknesses. The precursor of the first binder 31 in the liquid composition can function, for example, to bind the first hollow fine particles 21 to each other or to bind the first hollow fine particles 21 to the surface of the substrate 3. The precursor of the first binder 31, which is included in a quantity greater than necessary for binding the first hollow fine particles, can migrate to the surface of the substrate 3 or the like, and solidify to form a part of the second layer 12, in the manufacture of the antireflection film 1a. As described above, the second layer 12 is filled with a solid that includes a part of the shells of the hollow fine particles 21, the first binder 31 or the like, and the second layer 12 is a layer with a relatively high refractive index in the first multilayer structure 10. The first binder 31 includes, for example, a hydrolysate of an alkoxysilane or a polymer thereof.

The ratio of the mass of the solid content of the first hollow fine particles 21 to the mass of the solid content of the liquid composition as the precursor of the first multilayer structure 10 is preferably 90% or more, more preferably 95% or more, and even more preferably 99% or more.

The liquid composition that is the precursor of the first multilayer structure 10 includes, for example, at least one selected from the group consisting of alkoxysilane and a hydrolysate of an alkoxysilane as the precursor of the first binder 31. In this case, the alkoxysilane includes tetrafunctional alkoxysilane and trifunctional alkoxysilane, and a molar ratio of the tetrafunctional alkoxysilane to the trifunctional alkoxysilane is not limited to a specific value. The ratio is, for example, from 1/9 to 9. In this case, the first layer 11 and the second layer 12 are likely to have desired refractive indices and desired thicknesses. In addition, the first multilayer structure 10 is likely to have a desired mechanical strength and high transparency.

The antireflection film 1a can be produced, for example, by coating a liquid composition on the substrate 3 and solidifying the liquid composition, where the liquid composition includes the first hollow fine particles 21 and at least one selected from the group consisting of an alkoxysilane and a hydrolysate thereof. A mass ratio of the first hollow fine particles 21 to the liquid composition is 80% to 99.5%. The antireflection film 1a includes the first layer 11 and the second layer 12 separated from each other. By this method, the antireflection film 1a with the first layer 11 and the second layer 12 can be produced relatively easily from a single liquid composition.

The method of coating the liquid composition as precursor of the antireflection film 1a along the substrate 3 is not limited to a specific method. Examples of the methods include roll coating, spray coating, spin coating, dispenser coating, inkjet coating, screen printing, and dip coating. Requirements for the coating method are adjusted in accordance with the required thickness of the coating film. For example, in the case of dip coating, when the viscosity of the liquid composition is represented by η [Pa·s] and the rate at the time of withdrawal are represented by v [m/s], the thickness of the coating film, for example, the thickness of the first multilayer structure 10 t_{LL}, is proportional to η^{j}×v^{k}. Here, requirements j=0.5 to 0.6 and k=0.5 to 0.7 are satisfied. In addition, when the rotational angular velocity is ω [radians/second] in the coating process by spin coating, the thickness of the coating film is proportional to η^{1/3}/ω^{2/3}.

The method of solidifying the liquid composition is not limited to a specific method. The solidification of the liquid composition may be carried out in accordance with a method in which the coating film is dried by heating or in which polymerization of the binder precursor or the like occurs. In this case, heating may be carried out in an environment kept at approximately room temperature, especially in an environment where there is no artificial heating means. For example, the liquid composition may be left to stand in the interior of a container, in a constant temperature bath, on a desk or the like, thereby solidifying as a result of drying or reaction. Solidification of the liquid composition may be carried out by polymerizing the precursor or the like for binder by irradiating with electromagnetic waves such as visible light, ultraviolet rays, or microwaves.

A coating film refers to a liquid composition coated on the surface of a substrate, regardless of whether the coating film is a sol or a gel. Solidification includes the following mechanisms: the molecular weight of the binder component included in the liquid composition increases due to polymerization of the compound included in the liquid composition, causing the liquid composition to gelate; the solvent included in the liquid composition or a liquid by-product is removed by evaporation or the like, causing the liquid composition to dry and gelate; and the liquid composition solidifies due to a mechanism associated with mixing the liquid composition. Alternatively, the solidification may include a combination of these mechanisms. In addition, solidification includes: the reaction of the liquid composition, the drying or the like progresses to produce a solid including an organic compound and an inorganic compound; organic matters in the liquid composition is removed to produce a solid consisting almost entirely of inorganic matter, and a mixture of these solids is obtained.

Various cleaning or surface treatments may be carried out on the surface of the substrate 3 to which the liquid composition is to be applied before the liquid composition is applied. The method of cleaning the surface of the substrate 3 is not limited to a specific method. The cleaning of the surface of the substrate 3 may be a cleaning with an organic solvent or water, or it may be an acid or alkali cleaning involving immersion or the like in an acid or alkali solution. Examples of surface treatments for the surface of the substrate 3 include mechanical treatments such as sandblasting and polishing, corona discharge treatment, flame treatment, UV-O₃ cleaning, and plasma irradiation treatment. It is expected that these cleaning or surface treatment processes will bring benefits such as improving the wettability of the liquid composition on the surface of the substrate 3, or generating hydroxy groups or the like that are easily bonded to the compounds included in the liquid composition.

In the manufacture of the antireflection film 1a, it is preferable to allow the gelation of the liquid composition to occur relatively slowly after forming a coating film of the liquid composition along the surface of the substrate 3. In this case, the fluidity of the fine particles or the binder precursor can be maintained to a certain extent before the gelation of the liquid composition. Therefore, it is preferable that the layers configuring the antireflection film 1a are solidified by drying or heating the liquid composition with heat rather than solidifying the liquid composition rapidly by irradiating with electromagnetic waves or the like. The temperature for heating the liquid composition is, for example, 600° C. or lower, preferably 400° C. or lower, more preferably 300° C. or lower, and even more preferably 250° C. or lower. Though the time for heating the liquid composition depends on the heating temperature, the time is, for example, 2 hours or less, preferably 1 hour or less, more preferably 30 minutes or less, and even more preferably 15 minutes or less. Such heating conditions can be determined by taking into account the properties required for the antireflection film 1a, the heat resistance temperature of the substrate 3 or the like. For example, if the heating temperature of the liquid composition is high, the resulting film will be dense and hard, but there is a trade-off in that it is more likely to crack and become brittle.

As described above, the refractive index n_{L2} of the second layer 12 is 1.30 to 1.55, and the thickness t_{L2} of the second layer 12 is 25 nm or less. In addition, the refractive index n_{L1} of the first layer 11 is 1.10 to 1.35, and the thickness t_{L1} of the first layer 11 is 80 nm to 150 nm. The measurement or calculation of the physical parameters of each layer of the antireflection film 1a may be carried out as follows. The average particle diameter Dₚ of the hollow fine particles 21 and the thickness t_{LL} of the first multilayer structure 10, which includes the first layer 11 and the second layer 12, are measured from an SEM image or the like of a cross-section of the antireflection film 1a. In addition, the reflection spectrum of the antireflection film 1a is measured using a spectrophotometer or the like. Next, with appropriate simulation software, the values of the parameters corresponding to the refractive indices and the thicknesses of the first layer 11 and second layer 12 are successively changed, assuming that each layer is filled with a uniform medium, and the reflection spectrum is calculated. Then, fitting is performed. In the fitting process, for example, the refractive index and the thickness of each layer are measured using a spectrophotometer or the like and determined so that a specific error parameter between the measured reflection spectrum and the calculated reflection spectrum is minimized. The main function of the antireflection film 1a is to prevent reflection on the surface of a transparent optical component or a substrate. As a result, the reflectance of the measured reflection spectrum of the antireflection film 1a tends to be low. For this reason, for example, the antireflection film 1a may be formed on the surface of a silicon wafer with a known refractive index dispersion using the same method and requirements as in the case of forming the antireflection film 1a on the surface of the substrate 3, and the measured reflection spectrum of the antireflection film 1a formed on the surface of the silicon wafer may be used for the fitting. In the calculation of the reflection spectrum, the thickness t_{L2} of the second layer 12 may be assumed to be less than the thickness t_{S} of the shells of the hollow fine particles 21. In the calculation of the reflection spectrum, the value of the parameter corresponding to the thickness t_{L2} of the second layer 12 may be determined specifically to a specific thickness, for example 4 nm, 2 nm or the like, which is determined by taking into account the amount of solid content in the liquid composition.

The specific error parameters between the measured reflection spectrum and the calculated reflection spectrum used in the fitting are not limited to specific parameters. Examples of the error parameters include a correlation coefficient, a root mean square value (rms value), a mean square value (MS value), and a mean absolute difference (MA value). In the case of determining each parameter for the antireflection film 1a, the integral value of the absolute difference (IA value: Integrate of Absolute) at each wavelength may be used for the measured reflection spectrum and the calculated reflection spectrum. In the case where the measured reflection spectrum and the calculated reflection spectrum are obtained for each unit wavelength (for example, 1 nm), the sum of the absolute differences in reflectance at each wavelength may be used instead of the IA value. The IA value is determined according to the following Formula (1). In Formula (1), rₘ is the measured reflectance at a wavelength λ, and rₛ is a reflectance at wavelength λ obtained by the calculation. |rₘ−rₛ| is the absolute value of the difference in reflectance, and λ₁ and λ₂ indicate an integration range or a range for which the sum is to be calculated. The sum of the absolute difference in reflectance is determined according to the following Formula (2).

$${\int }_{{λ}_{1}}^{{λ}_{2}} \vert {r}_{m} - {r}_{s} \vert d λ \qquad ( 1 )$$

$${\sum }_{{λ}_{1}}^{{λ}_{2}} \vert {r}_{m} - {r}_{s} \vert \qquad ( 2 )$$

In the antireflection film 1a, the IA value or the sum of the absolute difference of the reflectance is preferably 20% or less, more preferably 18% or less, and even more preferably 15% or less. The range in which the IA value or the sum of the absolute difference of the reflectance is determined can be included within the range of 300 nm to 1200 nm, for example. That range may be included within the range of 350 nm to 900 nm, or within the range of 400 nm to 850 nm, taking into account the accuracy of the spectrophotometer used for measurement or the like.

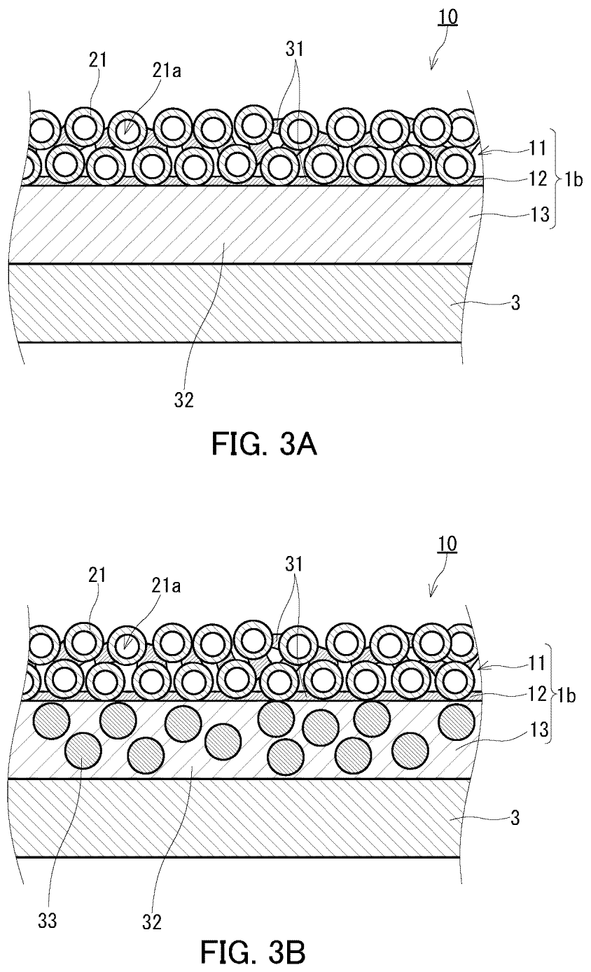

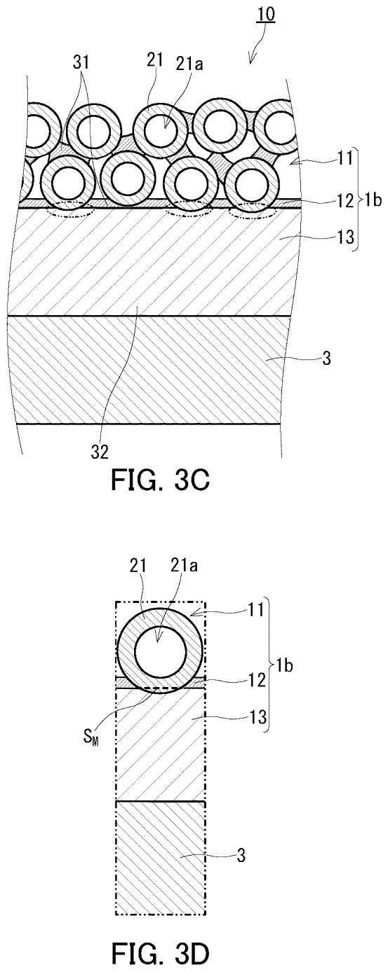

The antireflection film 1a can be modified from various viewpoints. The antireflection film 1a can be modified, for example, like the antireflection film 1b as shown in FIG. 3A or FIG. 3B. The antireflection film 1b is configured similarly to the antireflection film 1a, except for the parts that are specifically explained. The components of the antireflection film 1b which are the same as or correspond to the components of the antireflection film 1a are denoted by the same reference characters, and the detailed description thereof is omitted. The description for the antireflection film 1a is also applied to the antireflection film 1b unless there is a technical contradiction.

As shown in FIG. 3A or FIG. 3B, the antireflection film 1b further includes a third layer 13 disposed between the second layer 12 and the substrate 3 in the thickness direction of the antireflection film 1b. The third layer 13 has a refractive index n_{L3} of 1.35 to 2.25 and a thickness t_{M3} of 60 nm to 200 nm. With this configuration, the antireflection film 1b is likely to exhibit high antireflection performance. The antireflection film 1b tends to have a low reflectance at specific wavelengths, for example, at the design center wavelength. And the low-reflectance band, which is the wavelength band in which the reflectance is kept below a specific value, tends to be large. The refractive index n_{L3} is the value at the D line (589.3 nm).

The refractive index n_{L3} may be 1.40 to 1.85. In the antireflection film 1b, it is preferable that a requirement n_{L1}<n_{L3}<n_{L2} is satisfied. In this case, the antireflection film 1b is more likely to exhibit high antireflection performance. In the antireflection film 1b, a requirement n_{L1}<n_{L2}≤n_{L3} may be satisfied. The thickness t_{M3} may be 70 nm to 180 nm.

In the antireflection film 1b, the minimum value rₘᵢₙ₍₂₎ of the reflectance at a wavelength of 300 nm to 1200 nm is, for example, 1% or less, more preferably 0.5% or less, and even more preferably 0.2% or less. In addition, in the reflection spectrum of the antireflection film 1b, a wavelength range λ_{range/1.0}, in which a reflectance is 1% or less in a wavelength range of 300 nm to 1200 nm is, for example, 250 nm or more.

The material to form the third layer 13 is not limited to a specific material, as long as the third layer 13 has the refractive index and the thickness described above. The third layer 13 may be a layer that includes a dielectric such as a metal oxide or metal fluoride. The third layer 13 may be a dielectric film produced by a physical method (hereinafter referred to as “physical vapor deposition”), for example, vacuum deposition, sputtering, ion plating or the like, or it may be a so-called dielectric multilayer film in which multiple dielectrics are laminated. The dielectric material is not limited to any specific material. Examples of the dielectric materials include SiO₂, MgF₂, TiO₂, Ta₂O₃, AlF₃, CaF₂, Al₂O₃, ZrO₂, WO₃, CeO₂, ITO, ATO, and mixtures thereof. The dielectric layers can be produced using well-known methods such as physical vapor deposition.

The third layer 13 may be a layer obtained by solidifying a coating film by drying and reacting, the coating film being formed by applying a curable liquid composition along the surface of the substrate 3. In this case, as shown in FIG. 3B, the curable liquid composition to be a precursor of the third layer 13 may include fine particles 33, and may also include a second binder 32 to bind the fine particles 33 to each other. In the case where the third layer 13 is produced using such a curable liquid composition, equipment such as a vapor deposition device for a physical vapor deposition method or the like is not required, whereby the cost for manufacturing the antireflection film 1b is likely to be reduced. In the case where the third layer 13 is produced using a curable liquid composition, as shown in FIG. 3A, the third layer 13 may be free of the fine particles 33 and may include only the second binder 32.

In the case where the third layer 13 is produced by solidification of a curable liquid composition, the refractive index of the fine particles 33 included in the third layer 13 is, for example, 1.25 to 2.75. The material of the fine particles 33 included in the third layer 13 is not limited to a specific material. The fine particles 33 can be hollow or solid fine particles including, for example, a metal oxide or a metal fluoride, such as SiO₂, MgF₂, TiO₂, Ta₂O₃, AlF₃, CaF₂, Al₂O₃, ZrO₂, WO₃, CeO₂, indium tin oxide (ITO), or antimony tin oxide (ATO). The fine particles 33 may include a plurality of types of fine particles selected from these fine particles. The fine particles 33 may be fine particles made of resin. The fine particles 33 may include, for example, solid fine particles including polymethyl methacrylate, polyethylene, polystyrene, benzoguamine (melamine), or silicone as its main component, and may include multiple types of fine particles selected from these.

The third layer 13 may include a layer of the following (i) or (ii), or layers of (i) and (ii):
(i) a layer including a dielectric film including one or at least two oxides selected from the group consisting of SiO₂, MgF₂, TiO₂, Ta₂O₃, AlF₃, CaF₂, Al₂O₃, ZrO₂, WO₃, CeO₂, indium tin oxide, and antimony tin oxide; and
(ii) a layer including: fine particles of an oxide composed of one or at least two materials selected from the group consisting of SiO₂, TiO₂, ZrO₂, CeO₂, indium tin oxide, and antimony tin oxide; and a binder for binding the fine particles of the oxide.

Since the third layer 13 is disposed closer to the substrate 3 than the first layer 11 and second layer 12 in the thickness direction of the antireflection film 1b, it may be appropriate for the third layer 13 to have a relatively high refractive index from the viewpoint of enhancing antireflection performance. In this case, for example, the fine particles 33 included in the third layer 13 are preferably solid fine particles. Considering the refractive index required for the third layer 13, the fine particles 33 may include metal oxides, for example, titanium oxide (TiO₂, refractive index of 2.50 to 2.75, specific gravity of 4.1 to 4.4), zirconium oxide (ZrO₂, refractive index of 2.00 to 2.20, specific gravity of 5.5), cerium oxide (CeO₂, refractive index of 2.00 to 2.30, specific gravity of 7.0), ATO (refractive index of 1.70 to 1.85, specific gravity of 6.6), ITO (refractive index of 1.90 to 2.20, specific gravity of 7.1) or the like, and the fine particles 33 may include silicon oxide (SiO₂, refractive index of 1.41 to 1.48). The fine particles 33 may be hollow fine particles in the case where it is reasonable from the viewpoint of antireflection performance.

The average particle diameter of the fine particles 33 is not limited to a specific value. For example, the average particle diameter is 5 nm to 200 nm. Since the average particle diameter of the fine particles 33 is 5 nm or more, the cost for manufacturing the fine particles 33 is likely to be reduced. Since the average particle diameter of the fine particles 33 is 200 nm or less, haze of the antireflection film 1b may be prevented from increasing, where the increase in the haze is caused by light scattering accompanying the incidence of light. The average particle diameter of the fine particles 33 is preferably 10 to 100 nm, and more preferably 30 to 80 nm. The average particle diameter of the fine particles 33 included in the third layer 13 can be measured in the same way as the method for measuring the average particle diameter Dₚ of the first hollow fine particles 21.

A proportion of content of fine particles 33 to a solid content of the third layer 13 is not limited to a specific value. The proportion of content is, for example, 0% to 75% by mass. This makes it easier for the third layer 13 to have a desired refractive index. As mentioned above, the third layer 13 may be free of fine particles. Even in the case where the third layer 13 is required to have a relatively high refractive index, the third layer 13 may be free of fine particles as long as the antireflection film 1b can exhibit the predetermined antireflection performance. At this time, the third layer 13 includes, for example, a binder 32 as its main component. In this case, procurance of fine particles, adjustment and mixing thereof are not required in the preparation of the liquid composition that is a precursor of the third layer 13, and the cost for manufacturing the antireflection film 1b is likely to be reduced.

FIG. 3C and FIG. 3D are cross-sectional views showing a state of the first hollow fine particles 21 in the antireflection film shown in FIG. 3A. As shown in FIG. 3C and FIG. 3D, in the antireflection film 1b, a part of the first hollow fine particle 21 included in the first layer 11 and second layer 12 may be present in the third layer 13 and at the boundary plane of the third layer 13 distal to the substrate 3. For example, it is regarded that, since the liquid composition that is the precursor of the first multiple structure 10 is solidified after formation of the third layer 13, a part of the hollow fine particle 21 included in the first layer 11 and the second layer 12 becomes embedded in the third layer 13, and this may allow the part of the first hollow fine particle 21 to be present at the boundary plane of the third layer 13 distal to the substrate 3. The parts surrounded by double dotted lines in FIG. 3C indicate the parts of the hollow fine particles 21 embedded in the third layer 13. From the viewpoint of achieving the first hollow fine particles 21 with a part thereof being embedded in the third layer 13, desirably the components and the composition of the third layer 13 are similar to the components and the composition of the multilayer structure 10. In particular, if the first binder 31 and the second binder 32 are similar, and further the precursor of the first binder 31 and the precursor of the second binder 32 are also similar, it is easy for the precursor of the first binder 31 and the precursor of the second binder 32 to mix in manufacturing the antireflection film 1b. For example, if pores are formed in the third layer 13, the liquid composition applied to the surface of the third layer 13 distal to the substrate 3 may seep in to fill the pores. Thereby, since some of the compounds included in the first binder 31 are also included in the second binder 32, the first binder 31 and the second binder 32 can become homogeneous. As a result, it is regarded that the surface of the third layer 13 softens, and a part of the first hollow fine particles 21 is embedded in the third layer 13 and present at the boundary plane of the third layer 13 distal to the substrate 3. Here, the expression that the first binder 31 and the second binder 32 being similar involves the case where the components and the compositions of the two binders are the same. It also involves the case where the types of compounds included in the binders, such as alkoxysilanes, are similar. Specifically, the expression involves the case where the trifunctional alkoxysilane or the tetrafunctional alkoxysilane included in the two binders are the same type of alkoxysilane. It is known that pores can be formed during solidification of the liquid compositions including an alkoxysilane, and that a part of the uncured liquid composition is likely to seep into parts with such pores.

As shown in FIG. 3C, it is possible to identify the first hollow fine particles 21 present at the boundary of the third layer 13 distal to the substrate 3 within the range having a predetermined cross-sectional area of the cross-section of the antireflection film 1b, and to count the number of the first hollow fine particles 21. In addition, as shown in FIG. 3D, for each of the first hollow fine particles 21 present at this boundary, the proportion of its portion present closer to the third layer 13 to the entire first hollow fine particle 21 may be determined. A SEM image of the cross-section of the antireflection film 1b magnified 100,000 times is obtained to identify the first layer 11, the second layer 12, and the third layer 13. Then, a target cross-section of 500 nm square is determined to include all layers in the thickness direction. The first hollow fine particle 21 included in the target cross-section and present at the boundary of the third layer 13 distal to the substrate 3 is determined, and the first hollow fine particle 21 is approximated with a circle. The number N_{M1} of first hollow fine particles 21 included in the target cross-section and have parts that belong to both the second layer 12 and the third layer 13 is calculated by measuring a ratio S_{M}/S_{L} of an area S_{M} of the partial circle (a shape with part of the circle missing) included in the area closer to the third layer 13 to the total area S_{L} of the approximated circle of the first hollow fine particles 21 that have parts that belong to both the second layer 12 and the third layer 13. In the antireflection film 1b, the number N_{M1} is 1 to 5 for example, and preferably 3 to 5. The ratio S_{M}/S_{L} is 5% to 50% for example. If the first hollow fine particles 21 are present at the boundary of the third layer 13 distal to the substrate 3, the first hollow fine particles 21 are bound by both the binder of the third layer 13 and the binder of the layer contacting the third layer 13, so that the bonding strength between the third layer 13 and the layer contacting the boundary of the third layer 13 distal to the substrate 3 tends to be high.

The fine particles 33 included in the third layer 13 are not limited to specific fine particles. The fine particles 33 may be titanium oxide fine particles such as: TTO-51 and TTO-55 series manufactured by ISHIHARA SANGYO KAISHA, LTD.; JMT-150B, JMT-150AO, JMT-150ANO, and MTY-700BS manufactured by TAYCA Co, Ltd.; STT-65C-S and STT-30EHJ manufactured by Titan Kogyo, Ltd.; or OPTOLAKE series manufactured by JGC Catalysts and Chemicals Ltd. The fine particles 33 may be niobium oxide fine particles such as: Nb-G6000, Nb-G6100, and Nb-G6600 manufactured by TAKI CHEMICAL CO., LTD.; or niobium oxide manufactured by MITSUI MINING & SMELTING CO. LTD. The fine particles 33 may be zirconium oxide fine particles such as: ZIRCOSTAR manufactured by NIPPON SHOKUBAI CO., LTD.; or HXU-110JC manufactured by SUMITOMO OSAKA CEMENT Co., Ltd. The fine particles 33 may be silicon oxide fine particles such as: QSG series manufactured by Shin-Etsu Chemical Co., Ltd.; SNOWTEX® series manufactured by Nissan Chemical Corporation; or Thrulya series manufactured by JGC Catalysts and Chemicals Ltd. The fine particles 33 may be magnesium fluoride nanoparticles manufactured by Stella Chemifa Corporation. The fine particles 33 may be aluminum oxide fine particles such as: 100, 200, and 500 series of alumina sol manufactured by Nissan Chemical Corporation; or AS-150T and AS-150L manufactured by SUMITOMO OSAKA CEMENT Co., Ltd. The fine particles 33 may be polyethylene fine particles such as: polyethylene particles manufactured by COREFRONT; or Mipelon series manufactured by Mitsui Chemicals, Inc. The fine particles 33 may be polystyrene fine particles such as: polystyrene particles manufactured by COREFRONT; or Polybead polystyrene manufactured by TECHNO CHEMICAL Corp. The fine particles 33 may be ITO fine particles such as: ITO series manufactured by Mitsubishi Materials Electronic Chemicals Co. Ltd.; or P-120 and P-130 manufactured by JGC Catalysts and Chemicals Ltd. The fine particles 33 may be ATO fine particles such as: T-I series manufactured by Mitsubishi Materials Electronic Chemicals Co. Ltd. One type of the fine particles 33 may be used alone, or two or more types of fine particles may be mixed and used, to which fine particles other than these examples may be added. Furthermore, when conductive fine particles such as ITO and ATO are used as the fine particles 33, the antireflection film 1b can exhibit an anti-static function. The fine particles 33 are selected and combined as appropriate in accordance with the application and the function required for the antireflection film 1b.

In the case where the third layer 13 is produced by solidifying a curable liquid composition, the second binder 32 included in the third layer 13 is not limited to a specific binder. The second binder 32 may be selected in consideration of the circumstances in the description of the binder, regarding the antireflection film 1a. The second binder 32 may include at least one selected from the group consisting of an alkoxysilane, a hydrolysate of an alkoxysilane, and a polymer of a hydrolysate of an alkoxysilane.

The liquid composition that is the precursor of the third layer 13 may include, in addition to the fine particles 33 and the precursor of the second binder 32, a cross-linking agent, a polymerization initiator, a leveling agent, a surfactant, a silane coupling agent or the like, as necessary.

Unlike the case of formation of the first multilayer structure 10 including the first layer 11 and the second layer 12, in the case where the third layer 13 is produced by solidifying a curable liquid composition, there is no need for the third layer 13 to be formed in two separate layers during the process of solidifying the coating film of a single type of liquid composition. The optical parameters, such as the refractive index, may be approximately uniform throughout the third layer 3.

The antireflection film 1b can be manufactured, for example, by a method that includes the following processes (Ib), (IIb), and (IIIb). The antireflection film 1b includes a first layer and a second layer separated from each other in this order from a surface of the antireflection film 1b.
(Ib) A third layer 13 including a dielectric is formed on the substrate 3.
(IIb) A first liquid composition including the first hollow fine particles 21 and at least one selected from the group consisting of an alkoxysilane and a hydrolysate of an alkoxysilane is coated on the surface of the third layer 13.
(IIIb) The first liquid composition is solidified.

In (Ib), the third layer 13 may be obtained by coating a second liquid composition including a precursor of the second binder 32 on the substrate 3 and solidifying the second liquid composition. In this case, the method of coating the second liquid composition on the substrate 3 is not limited to a specific method. Examples of the methods include roll coating, spray coating, spin coating, dispenser coating, inkjet coating, screen printing, and dip coating. In addition, requirements or the like for each application method can be set in accordance with the thickness required for the second coating film in each coating method.

The method of solidifying the liquid composition is not limited to a specific method. The solidification of the liquid composition may be carried out in accordance with a method in which the coating film is dried by heating or in which polymerization of the binder precursor or the like occurs. In this case, heating may be carried out in an environment kept at approximately room temperature, especially in an environment where there is no artificial heating means. For example, the liquid composition may be left to stand in the interior of a container, in a constant temperature bath, on a desk or the like, thereby solidifying as a result of drying or reaction. Solidification of the liquid composition may be carried out by polymerizing the precursor or the like for binder by irradiating with electromagnetic waves such as visible light, ultraviolet rays, or microwaves.

Various cleaning or surface treatments may be carried out on the surface of the substrate 3 to which the liquid composition is to be applied before the liquid composition is applied. The method of cleaning the surface of the substrate 3 is not limited to a specific method. The cleaning of the surface of the substrate 3 may be a cleaning with an organic solvent or water, or it may be an acid or alkali cleaning involving immersion or the like in an acid or alkali solution. Examples of surface treatments for the surface of the substrate 3 include mechanical treatments such as sandblasting and polishing, corona discharge treatment, flame treatment, UV-O₃ cleaning, and plasma irradiation treatment. It is expected that these cleaning or surface treatment processes will bring benefits such as improving the wettability of the liquid composition on the surface of the substrate 3, or generating hydroxy groups or the like that are easily bonded to the compounds included in the liquid composition.

In the manufacture of the antireflection film 1b, it is preferable to allow the gelation of the liquid composition to occur relatively slowly after forming a coating film of the liquid composition. In this case, the fluidity of the fine particles or the binder precursor can be maintained to a certain extent before the gelation of the liquid composition. Therefore, it is preferable that the layers configuring the antireflection film 1b are solidified by drying or heating the liquid composition with heat. The temperature for heating the liquid composition is, for example, 600° C. or lower, preferably 400° C. or lower, more preferably 300° C. or lower, and even more preferably 250° C. or lower. Though the time for heating the liquid composition depends on the heating temperature, the time is, for example, 2 hours or less, preferably 1 hour or less, more preferably 30 minutes or less, and even more preferably 15 minutes or less. Such heating conditions can be determined by taking into account the properties required for the antireflection film 1b, the heat resistance temperature of the substrate 3 or the like. For example, if the heating temperature of the liquid composition is high, the resulting film will be dense and hard, but there is a trade-off in that it is more likely to crack and become brittle.

The calculation of the parameters of the antireflection film 1b can be carried out in the same way as the calculation of the parameters of the antireflection film 1a. For example, an antireflection film 1b is formed on a surface of a substrate 3 or the like, and another antireflection film is formed on a surface of a silicon wafer using the same method and requirements as those used to form the antireflection film 1b. A SEM image of the cross-section is obtained, a thickness of each layer is measured, each fine particle included in each layer is determined, and an average particle diameter, the number N_{M1}, and a ratio S_{M}/S_{L} are measured for calculation. Furthermore, the reflection spectrum of the antireflection film 1b is measured, and the reflection spectrum is calculated using the refractive index and the thickness of each layer as variables, and the refractive index and the thickness of each layer are specified so that the error parameter between the measured reflection spectrum and the calculated reflection spectrum is minimized within an acceptable range. In this way, the parameters of each layer of the antireflection film 1b can be calculated. The reasons for the error parameter are as described for the antireflection film 1a.

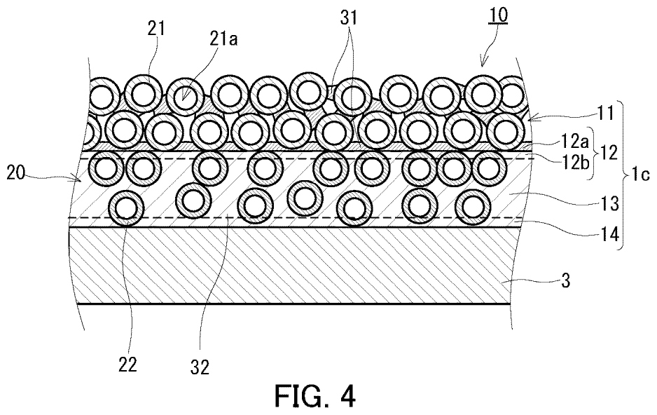

The antireflection film 1a may be modified, for example, as the antireflection film 1c shown in FIG. 4. The antireflection film 1c is configured similarly to the antireflection film 1a, except for the parts that are specifically explained. The components of the antireflection film 1c which are the same as or correspond to the components of the antireflection film 1a are denoted by the same reference characters, and the detailed description thereof is omitted. The descriptions for the antireflection films 1a and 1b are also applied to the antireflection film 1c unless there is a technical contradiction.

As shown in FIG. 4, the antireflection film 1c further includes a third layer 13 and a fourth layer 14. The third layer 13 is disposed between the second layer 12 and the substrate 3 in the thickness direction of the antireflection film 1c. The fourth layer 14 is disposed between the third layer 13 and the substrate 3 in the thickness direction of the antireflection film 1c. The third layer 13 has a refractive index n_{L3} of 1.30 to 2.25 and a thickness t_{M3} of 60 nm to 200 nm. The fourth layer 14 has a refractive index n_{L4} of 1.30 to 1.55 and a thickness t_{M4} of 25 nm or less. The refractive indices n_{L3} and n_{L4} are values at the D line (589.3 nm). With this configuration, the antireflection film 1c is likely to exhibit high antireflection performance. For example, the antireflection film 1c is likely to have a low reflectance at a specific wavelength (design center wavelength). The low-reflectance band, which is the wavelength range in which the reflectance is maintained below a specific value, is likely to be large.

In the antireflection film 1c, the minimum value rₘᵢₙ₍₂₎ of the reflectance at wavelengths of 300 nm to 1200 nm is, for example, 1% or less, preferably 0.5% or less, and more preferably 0.2% or less. In a reflection spectrum of the antireflection film 1c, a wavelength range λ_{range/1.0} in which a reflectance of 1% or less in the wavelength range of 300 nm to 1200 nm is 250 nm or more, for example.

The refractive index n_{L3} is preferably 1.40 to 2.00. The thickness t_{M3} is preferably 80 nm to 160 nm. The refractive index n_{L4} is preferably 1.35 to 1.50. The thickness t_{M4} is preferably 20 nm or less.

For example, in the antireflection film 1c, a requirement n_{L3}<n_{L4} may be satisfied. This makes it easier for the antireflection film 1c to exhibit high antireflection performance. In the antireflection film 1c, requirements n_{L1}<n_{L2} and n_{L3}<n_{L4} are preferably satisfied.

As shown in FIG. 4, the first layer 11 and the second layer 12 form the first multilayer structure 10 in the antireflection film 1c. In addition, the third layer 13 and fourth layer 14 form the second multilayer structure 20. The first multilayer structure 10 includes the first hollow fine particles 21 and the first binder 31 that binds the first hollow fine particles 21. The second multilayer structure 20 includes the second hollow fine particles 22 and the second binder 32 that binds the second hollow fine particles 22. With this configuration, the antireflection film 1c is more likely to exhibit high antireflection performance.

In the antireflection film 1c, the difference between the refractive index of the first binder 31 and the refractive index of the second binder 32 is not limited to a specific value. For example, the difference is 0.01 or less. With this configuration, the antireflection film 1c is more likely to exhibit high antireflection performance.

As shown in FIG. 4, the second layer 12 includes, for example, a first portion 12a and a second portion 12b. The first portion 12a of the second layer 12 is a layered portion disposed facing the first layer 11. The second portion 12b of the second layer 12 is a layered portion disposed facing the third layer 13.

The antireflection film 1c can be manufactured, for example, using a liquid composition group that is a precursor of the antireflection film 1c. This liquid composition group includes a first liquid composition and a second liquid composition. The first liquid composition includes, for example, the first hollow fine particles 21 and a precursor of the first binder 31. The first layer 11 and the first portion 12a of the second layer 12 can be formed by solidifying the first liquid composition. The second liquid composition includes a precursor of the second hollow fine particles 22 and a precursor of the second binder 32. The second portion 12b of the second layer 12, the third layer 13, and the fourth layer 14 can be formed by solidifying the second liquid composition.

The antireflection film 1c can be manufactured, for example, by a method including the following steps (Ic) and (IIc).
(Ic) The second portion 12b of the second layer 12, the third layer 13, and the fourth layer 14 are formed by at least one selected from the group consisting of drying of a second coating film obtained by applying the second liquid composition along the surface of the substrate 3, and a reaction of the second coating film.
(IIc) The first portion 12a of the second layer 12 and the first layer 11 are formed separated from each other, and the first portion 12a and the second portion 12b are combined to form the second layer 12, by at least one selected from the group consisting of drying of a first coating film obtained by applying the first liquid composition on the second portion 12b of the second layer 12 and a reaction of the first coating film.

The antireflection film 1c may be manufactured, for example, by a method including the following steps (Id), (IId), (IIId), and (IVd).
(Id) A second liquid composition is coated on a substrate 3, where the second liquid composition includes oxide-containing second fine particles and at least one selected from the group consisting of an alkoxysilane and a hydrolysate of an alkoxysilane.
(IId) The second liquid composition is solidified.
(IIId) A first liquid composition is coated on a surface of the solidified product of the second liquid composition, where the first liquid composition includes the first hollow fine particles 21 and at least one selected from the group consisting of alkoxysilane and a hydrolysate of an alkoxysilane.
(IVd) The first liquid composition is solidified.

The antireflection film 1c includes, for example, the first layer 11, the second layer 12, the third layer 13, and the fourth layer 14 separated from each other in this order from the surface of the antireflection film 1c. The second layer 12 includes a part of the shells of the first hollow fine particles 21, a part of the polymer of the hydrolysate of the alkoxysilane, and a part of the second fine particles.

In (Id), a mass ratio of the second fine particles to the second liquid composition is, for example, 5% to 75%. In (IIId), a mass ratio of the first hollow fine particles 21 to the first liquid composition is, for example, 80% to 99.5%.

Both the precursor of the first binder 31 and the precursor of the second binder 32 may include a predetermined alkoxysilane, and the first layer 11, the second layer 12, the third layer 13, and the fourth layer 14 may include at least one of a hydrolysate of an alkoxysilane and a polymer of a hydrolysate of an alkoxysilane. The predetermined alkoxysilane is an alkoxysilane that is at least one precursor selected from the group consisting of a hydrolysate of an alkoxysilane and a polymer of a hydrolysate of an alkoxysilane, for example, the difference between the refractive index of the first binder 31 and the refractive index of the second binder 32 can be 0.01 or less. For example, in the case of a predetermined alkoxysilane, a molar ratio of a trifunctional alkoxysilane to a tetrafunctional alkoxysilane is 1/4 to 4. With this configuration, in the step (IIc), the first portion 12a and the second portion 12b are combined to form a substantially uniform layer, where the first layer 11, the second layer 12, the third layer 13, and the fourth layer 14 are disposed in this order toward the substrate 3.

As shown in FIG. 4, among the first layer 11, the second layer 12, the third layer 13 and the fourth layer 14 all of which are included in the antireflection film 1c, the fourth layer 14 located closest to the substrate 3 includes a material to form the shells of the hollow fine particles 22. For example, in the case where the first binder 31 and the second binder 32 include at least one selected from the group consisting of a hydrolysate of an alkoxysilane and a polymer of a hydrolysate of an alkoxysilane, and the first hollow fine particle 21 and the second hollow fine particle 22 are composed of a compound whose main component is silicon oxide, the fourth layer 14 can be filled with a compound whose main component is silicon oxide. For example, in the case where the shells of the second hollow fine particles 22 are formed of a compound whose main component is silicon oxide and the shells include a hydrolysate of an alkoxysilane or a polymer of a hydrolysate as a main component, the fourth layer 14 will be filled with an alkoxysilane, a hydrolysate of an alkoxysilane, and a polymer of a hydrolysate of an alkoxysilane, as there is substantially no hollow portions, voids or the like to be filled with air. As a result, the refractive index n_{L4} of the fourth layer 14 can be a value that is not significantly different from the refractive index of silicon oxide or a derivative thereof. Furthermore, the material to form the shells of the hollow fine particles 22 may include a material other than silicon oxide, as long as the fourth layer 14 has a refractive index n_{L4} of 1.30 to 1.55 and its t_{M4} is 25 nm or less.

The third layer 13 can be disposed at a position farther from the substrate 3 than the fourth layer 14. As shown in FIG. 4, the third layer 13 is a layer that includes the shells and hollow portions of the second hollow fine particles 22, and air with a refractive index of approximately 1 is present in the hollow portions of the second hollow fine particles 22 and the voids between the second hollow fine particles 22. As a result, when the proportion of the region including such air in the third layer 13 is larger, the refractive index n_{L3} of the third layer tends to be lower. The second liquid composition is applied before applying the first liquid composition, and a part of the second hollow fine particles 22 can be present at the boundary of the second portion 12b distal to the substrate 3 during the process of forming the second portion 12b, the third layer 13, and the fourth layer 14. Just like the fourth layer 14, the second portion 12b, may include, for example, the second binder 32 and in addition, a compound that forms the shells of the second hollow fine particles 22, which include silicon oxide, for example, as a main component. In the case where the layer to form the antireflection film 1c includes alkoxysilane, a hydrolysate of an alkoxysilane, or a polymer of a hydrolysate of an alkoxysilane, and the second hollow fine particles 22 are formed of a compound whose main component is silicon oxide, the second portion 12b can be filled with the compounds whose main component is silicon oxide. In the case where the hollow fine particles formed of a compound including silicon oxide as a main component are formed from a compound including a hydrolysate of an alkoxysilane or a compound including a polymer of a hydrolysate of an alkoxysilane as a main component, the second portion 12b is unlikely to include hollow portions, voids or the like, and is filled with alkoxysilane, a hydrolysate of an alkoxysilane, or a polymer of a hydrolysate of an alkoxysilane. Therefore, in the antireflection film 1c, the refractive index of the second portion 12b can be a value that is not significantly different from the refractive index of silicon oxide or a modified silicon oxide.

In the step (IIc), the first portion 12a of the second layer 12 and the first layer 11 are formed separated from each other. The formation of the first layer 11 and the first portion 12a of the antireflection film 1c corresponds to the formation of the first layer 11 and the second layer 12 of the antireflection film 1a, respectively. Therefore, the formation of the first layer 11 and the first portion 12a in the antireflection film 1c can be referred to by replacing the explanation of the “second layer 12” of the antireflection film 1a with the “first portion 12a”.

In the antireflection film 1c, the first hollow fine particles 21 and the second hollow fine particles 22 may preferably be the same type of fine particles having shells that include silicon oxide as the main component. The first hollow fine particles 21 and the second hollow fine particles 22 may be the same or different types of fine particles that include as the main component a component other than silicon oxide, as long as the refractive index and thickness of each layer are within specified ranges. As described above, the first binder 31 and the second binder 32 are preferably selected so that the difference in refractive index between them is 0.01 or less.

A ratio M_{L} of a mass of a solid content of the first hollow fine particles 21 to a mass of a solid content of the first liquid composition is, for example, larger than a ratio M_{H} of a mass of a solid content of the second hollow fine particles 22 to a mass of a solid content of the second liquid composition. With this configuration, the antireflection film 1c is more likely to exhibit high antireflection performance.

As for the ratio M_{L} and the ratio M_{H} in the liquid composition group that is the precursor of the antireflection film 1c, a requirement 0.05≤M_{H}/M_{L}≤0.85 is preferably satisfied, and a requirement 0.2≤M_{H}/M_{L}≤0.7 is more preferably satisfied. This makes it easier for the antireflection film 1c to exhibit high antireflection performance.

The ratio M_{L} is, for example, 80% to 99.5%, preferably 85% to 99.5%, more preferably 90% to 99.5%, and even more preferably 95% to 99%. M_{H} is, for example, 5% to 70%, and preferably 10% to 50%.

The method of coating the first liquid composition and the second liquid composition, which are precursors of the antireflection film 1c, is not limited to a specific method. Examples of the methods include roll coating, spray coating, spin coating, dispenser coating, inkjet coating, screen printing, and dip coating. Requirements of the coating method are adjusted in accordance with the required thickness of the coating film.

The method of solidifying the first liquid composition and the second liquid composition is not limited to a specific method. The solidification of the liquid composition may be carried out in accordance with a method in which the coating film is dried by heating or in which polymerization of the binder precursor or the like occurs. In this case, heating may include solidification of the liquid composition by drying or reaction, even in an environment kept at room temperature, especially in an environment where there is no artificial heating means, for example, by being left to stand in the interior of a container, in a constant temperature bath, on a desk or the like. Solidification of the liquid composition may be carried out by polymerizing the precursor or the like for binder by irradiating with electromagnetic waves such as visible light, ultraviolet rays, or microwaves.

Various cleaning or surface treatments may be performed on the surface of the substrate 3 to which the second liquid composition is to be applied before the second liquid composition is applied. The method of cleaning the surface of the substrate 3 is not limited to a specific method. The cleaning of the surface of the substrate 3 may be a cleaning with an organic solvent or water, or it may be an acid or alkali cleaning involving immersion or the like in an acid or alkali solution. Examples of surface treatments for the surface of the substrate 3 include mechanical treatments such as sandblasting and polishing, corona discharge treatment, flame treatment, UV-O₃ cleaning, and plasma irradiation treatment. It is expected that these cleaning or surface treatment processes will bring benefits such as improving the wettability of the liquid composition on the surface of the substrate 3 or generating hydroxy groups or the like that are easily bonded to the compounds included in the liquid composition.

In the manufacture of the antireflection film 1c, it is preferable to allow the gelation of the liquid composition to occur relatively slowly after forming a coating film of the liquid composition along the surface of the substrate 3. In this case, the fluidity of the fine particles or the binder precursor can be maintained to a certain extent before the gelation of the liquid composition. Therefore, it is preferable that the layers configuring the antireflection film 1c are solidified by drying or heating the liquid composition with heat. The temperature for heating the liquid composition is, for example, 600° C. or lower, preferably 400° C. or lower, more preferably 300° C. or lower, and even more preferably 250° C. or lower. Though the time for heating the liquid composition depends on the heating temperature, the time is, for example, 2 hours or less, preferably 1 hour or less, more preferably 30 minutes or less, and even more preferably 15 minutes or less. Such heating conditions can be determined by taking into account the properties required for the antireflection film 1c, the heat resistance temperature of the substrate 3 or the like. For example, if the heating temperature of the liquid composition is high, the resulting film will be dense and hard, but there is a trade-off in that it is more likely to crack and become brittle.

The calculation of the parameters of the antireflection film 1c can be carried out in the same way as the calculation of the parameters of the antireflection film 1a. For example, an antireflection film 1c is formed on a surface of a substrate 3 or the like, and another antireflection film is formed on a surface of a silicon wafer, using the same method and requirements as those used to form the antireflection film 1c. A SEM image of the cross-section is obtained, a thickness of each layer is measured, each fine particle included in each layer is determined, and an average particle diameter, the number N_{M1}, and a ratio S_{M}/S_{L} are measured for calculation. Furthermore, the reflection spectrum of the antireflection film 1c is measured, and the reflection spectrum is calculated using the refractive index and the thickness of each layer as variables, and the refractive index and the thickness of each layer are determined so that the error parameter between the measured reflection spectrum and the calculated reflection spectrum is minimized within an acceptable range. In this way, the parameters of each layer of the antireflection film 1c can be calculated. The reasons for the error parameter are as described for the antireflection film 1a.

The antireflection films 1a, 1b, and 1c can be modified from various viewpoints. For example, the antireflection film may include k layers, where k represents the number of layers. In this case, the first layer 11, the second layer 12, the third layer 13, ( . . . ), and the k-th layer can be disposed in this order toward the substrate 3. k is an integer greater than or equal to 5, for example.

### EXAMPLES

The present invention will be explained in more detail with reference to Examples. The present invention is not limited to the following Examples.

### <Binder Precursor A1>

A binder precursor A1 that is a clear liquid composition was obtained by mixing and stirring 44.6 g of tetraethoxysilane (TEOS) and 16.4 g of methyltriethoxysilane (MTES) both of which are manufactured by Tokyo Chemical Industry Co., Ltd., and 37.9 g of a 0.3 mass % aqueous solution of formic acid manufactured by Kishida Chemical Co., Ltd. A molar ratio of TEOS to MTES in the binder precursor A1 was 7:3.

### <Binder Precursor A2>

A binder precursor A2 that is a clear liquid composition was obtained by mixing and stirring 33.6 g of TEOS, 28.6 g of MTES, and 37.9 g of a 0.3 mass % aqueous solution of formic acid manufactured by Kishida Chemical Co., Ltd. A molar ratio of TEOS to MTES in the binder precursor A2 was 5:5.

### <Binder Precursor A3>

A binder precursor A3 that is a clear liquid composition was obtained by mixing and stirring 19.0 g of TEOS, 38.0 g of MTES, and 37.9 g of a 0.3 mass % aqueous solution of formic acid manufactured by Kishida Chemical Co., Ltd. A molar ratio of TEOS to MTES in the binder precursor A3 was 3:7.

### <Binder Precursor A4>

A binder precursor A4 that is a clear liquid composition was obtained by mixing and stirring 5.8 g of TEOS, 45.2 g of MTES, and 37.9 g of a 0.3 mass % aqueous solution of formic acid manufactured by Kishida Chemical Co. Ltd. A molar ratio of TEOS to MTES in the binder precursor A4 was 1:9.

### <Binder Precursor A5>

A binder precursor A5 that is a clear liquid composition was obtained by mixing and stirring 19.2 g of TEOS, 36.1 g of n-propyltrimethoxysilane (n-PTMS), and 37.9 g of a 0.3 mass % aqueous solution of formic acid manufactured by Kishida Chemical Co., Ltd. A molar ratio of TEOS to n-PTMS in the binder precursor A5 was 3:7.

### <Liquid Composition B1>

A liquid composition B1 including hollow fine particles and a binder precursor was prepared by adding 0.14 g of the binder precursor A1 together with Thrulya 4110 manufactured by JGC Catalysts and Chemicals Ltd. to 86.0 g of a mixture of 1-methoxy-2-propanol and 3-methoxy-3-methyl-1-butanol such that a solid content mass of the fine particles to the total solid content mass would be 99%, followed by mixing and stirring. Here, Thrulya 4110 is a dispersion liquid including approximately 20 mass % of roughly spherical hollow silica fine particles, 70 mass % of 2-propanol, and 10 mass % of methanol, with an average particle diameter (nominal) of 60 nm and a refractive index of 1.25.

### <Liquid Composition B2>

A liquid composition B2 including hollow fine particles and a binder precursor was prepared by adding 2.7 g of the binder precursor A2 together with Thrulya 4110 manufactured by JGC Catalysts and Chemicals Ltd. to 82.3 g of a mixture of 1-methoxy-2-propanol and 3-methoxy-3-methyl-1-butanol such that a solid content mass of the fine particles to the total solid content mass would be 95%, followed by mixing and stirring.

### <Liquid Composition B3>

A liquid composition B3 including hollow fine particles and a binder precursor was prepared by adding 4.4 g of the binder precursor A3 together with Thrulya 4110 manufactured by JGC Catalysts and Chemicals Ltd. to 81.9 g of a mixture of 1-methoxy-2-propanol and 3-methoxy-3-methyl-1-butanol such that a solid content mass of the fine particles to the total solid content mass would be 90%, followed by mixing and stirring.

### <Liquid Composition B4>

A liquid composition B4 including hollow fine particles and a binder precursor was prepared by adding 3.7 g of the binder precursor A4 together with Thrulya 4110 manufactured by JGC Catalysts and Chemicals Ltd. to 81.3 g of a mixture of 1-methoxy-2-propanol and 3-methoxy-3-methyl-1-butanol such that a solid content mass of the fine particles to the total solid content mass would be 90%, followed by mixing and stirring.

### <Liquid Composition B5>

A liquid composition B5 including hollow fine particles and a binder precursor was prepared by adding 4.4 g of the binder precursor A5 together with Thrulya 4110 manufactured by JGC Catalysts and Chemicals Ltd. to 81.9 g of a mixture of 1-methoxy-2-propanol and 3-methoxy-3-methyl-1-butanol such that a solid content mass of the fine particles to the total solid content mass would be 95%, followed by mixing and stirring.

### <Liquid Composition B6>

A liquid composition B6 including hollow fine particles and a binder precursor was prepared by adding 14.8 g of the binder precursor A1 to 82.8 g of a mixture of 1-methoxy-2-propanol and 3-methoxy-3-methyl-1-butanol, followed by mixing and stirring.

### <Liquid Composition B7>

A liquid composition B7 including hollow fine particles and a binder precursor was prepared by adding 14.8 g of the binder precursor A1 together with Thrulya 4110 manufactured by JGC Catalysts and Chemicals Ltd. to 82.8 g of a mixture of 1-methoxy-2-propanol and 3-methoxy-3-methyl-1-butanol such that a solid content mass of the fine particles to the total solid content mass would be 13.1%, followed by mixing and stirring.

### <Liquid Composition B8>

A liquid composition B8 including hollow fine particles and a binder precursor was prepared by adding 14.8 g of the binder precursor A3 together with Thrulya 4110 manufactured by JGC Catalysts and Chemicals Ltd. to 82.8 g of a mixture of 1-methoxy-2-propanol and 3-methoxy-3-methyl-1-butanol such that a solid content mass of the fine particles to the total solid content mass would be 10.0%, followed by mixing and stirring.

### <Liquid Composition B9>

A liquid composition B9 including hollow fine particles and a binder precursor was prepared by adding 15.7 g of the binder precursor A1 together with titanium dioxide fine particles OPTOLAKE manufactured by JGC Catalysts and Chemicals Ltd. to 71.4 g of a mixture of 1-methoxy-2-propanol and 3-methoxy-3-methyl-1-butanol such that a solid content mass of the fine particles to the total solid content mass would be 54.2%, followed by mixing and stirring. Here, OPTOLAKE has an average particle diameter of 8 to 12 nm (nominal), and includes a solvent of methanol or the like.

### <Liquid Composition B10>

A liquid composition B10 including hollow fine particles and a binder precursor was prepared by adding 0.04 g of the binder precursor A1 together with Thrulya 4110 manufactured by JGC Catalysts and Chemicals Ltd. to 86.2 g of a mixture of 1-methoxy-2-propanol and 3-methoxy-3-methyl-1-butanol such that a solid content mass of the fine particles to the total solid content mass would be 99.8%, followed by mixing and stirring.

### Example 1

For a substrate, a sheet of borosilicate glass D263 T eco manufactured by Corning Incorporated (refractive index no of 1.5230) having a thickness of 2.1 mm was used. This substrate was properly washed with an alkaline solution and an organic solvent, and a suitable amount of the liquid composition B1 was dropped onto one of the main surfaces of this substrate, so that a coating film was formed by spin coating. This substrate had a square shape with a side length of 70 mm in a plan view. Next, the substrate with the coating film formed thereon was placed in a constant temperature drying oven and left to stand at 30° C. for 30 minutes. After that, the temperature inside the constant temperature drying oven was adjusted to 200° C. and maintained at 200° C. for 10 minutes. The temperature inside the constant temperature drying oven was then allowed to cool naturally to room temperature, and the substrate with the low-refractive-index layer was taken out from the constant temperature drying oven, whereby an antireflection film of Example 1 was obtained.

### Example 2

For a substrate, a sheet of borosilicate glass D263 T eco manufactured by Corning Incorporated (refractive index no of 1.5230) having a thickness of 2.1 mm was used. This substrate was properly washed with an alkaline solution and an organic solvent, and a suitable amount of the liquid composition B2 was dropped onto one of the main surfaces of this substrate, so that a coating film was formed by spin coating. Next, the temperature inside a constant temperature bath was adjusted to 200° C. in advance, and the substrate with the coating film formed thereon was placed inside the constant temperature bath and left to stand there. After 10 minutes, the substrate was taken out from the constant temperature bath and left to stand in a room at room temperature (25° C.) to cool it down, so that an antireflection film according to Example 2 was obtained.

### Example 3

An antireflection film according to Example 3 was prepared in the same way as Example 2, except that the liquid composition B4 was used instead of the liquid composition B2.

### Example 4

For a substrate, a sheet of borosilicate glass D263 T eco manufactured by Corning Incorporated (refractive index no of 1.5230) having a thickness of 2.1 mm was used. This substrate was properly washed with an alkaline solution and an organic solvent, and a suitable amount of the liquid composition B6 was dropped onto one of the main surfaces of this substrate, so that a coating film was formed by spin coating. Next, the temperature inside the constant temperature bath was adjusted to 200° C. in advance, and the substrate with the coating film formed thereon was placed inside the constant temperature bath and left to stand there. After 10 minutes, the substrate was taken out from the constant temperature bath and left to stand in a room at room temperature (25° C.) to cool it down, so that a lower layer according to Example 4 was obtained. Next, on the surface of this lower layer, a suitable amount of the liquid composition B1 was dropped, and a coating film was formed by spin coating. Next, the temperature inside the constant temperature bath was adjusted to 200° C. in advance, and the substrate with the coating film formed thereon was placed inside the constant temperature bath, and left to stand there. After 10 minutes, the substrate was taken out from the constant temperature bath and placed in a room at room temperature (25° C.) to cool it down, so that an antireflection film according to Example 4 was obtained.

### Example 5

An antireflection film according to Example 5 was produced in the same way as Example 4, except that the liquid composition B8 was used instead of the liquid composition B6, and the liquid composition B2 was used instead of the liquid composition B1.

### Example 6

An antireflection film according to Example 6 was produced in the same way as Example 4, except that the liquid composition B7 was used instead of the liquid composition B6, and the liquid composition B5 was used instead of the liquid composition B1.

### Example 7

An antireflection film according to Example 7 was produced in the same way as Example 4, except that the liquid composition B9 was used instead of the liquid composition B6.

### Example 8

For a substrate, a sheet of borosilicate glass D263 T eco manufactured by Corning Incorporated (refractive index no of 1.5230) having a thickness of 2.1 mm was used. This substrate was properly washed with an alkaline solution and an organic solvent, and a monolayer of SiO₂ was formed on one of the main surfaces of the substrate by vacuum deposition. The SiO₂ monolayer had a thickness of 103 nm.

Next, onto the surface of this SiO₂ monolayer, a suitable amount of the liquid composition B3 was dropped, and a coating film was formed by spin coating. The temperature inside the constant temperature bath was adjusted to 200° C. in advance, and the substrate with the coating film formed thereon was placed inside the constant temperature bath and left to stand there. After 10 minutes, the substrate was taken out from the constant temperature bath and left in a room at room temperature (25° C.) to cool it down, so that a lower layer according to Example 8 was obtained.

### Example 9

An antireflection film according to Example 9 was prepared in the same way as Example 4, except that the liquid composition B8 was used instead of the liquid composition B6, and the liquid composition B10 was used instead of the liquid composition B1.

Requirements for the antireflection films of each Example and the liquid compositions used to make these antireflection films are shown in Table 1.

### <Antireflection Film for Fitting>

For fitting of the reflection spectrum, a film corresponding to the antireflection film according to each Example was produced on a silicon wafer similarly to each Example, except that, a silicon wafer was used as the substrate instead of the D263 T eco sheet.

### <Measurement of Reflectance and Reflection Spectrum>

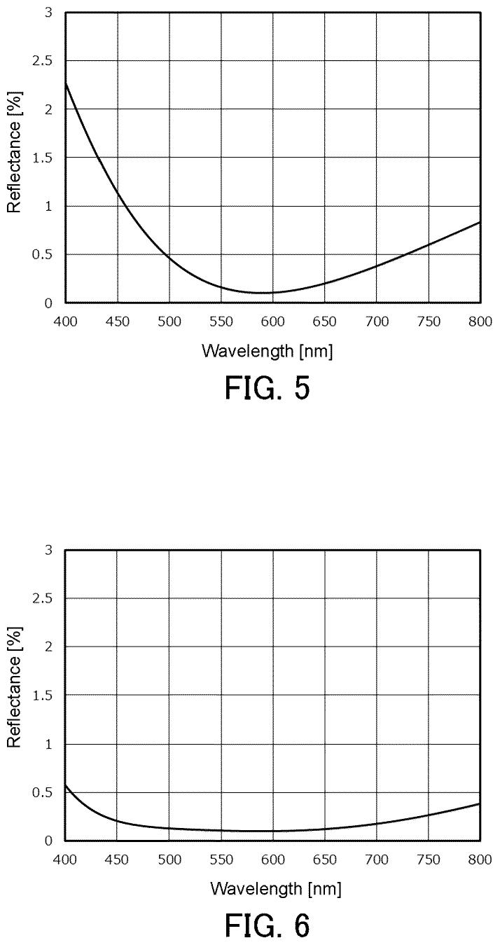

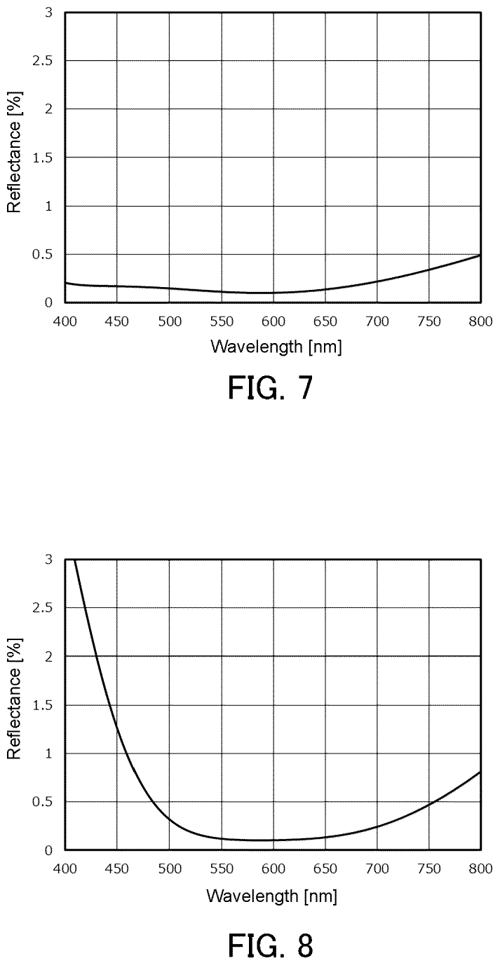

The reflection spectrum of the antireflection film at an incident angle of 5° in each Example was measured using a UV-visible-near infrared spectrophotometer V-770 manufactured by JASCO Corporation. In addition, the reflectance at the D line (wavelength of 589.6 nm) was obtained as a representative reflectance. The results are shown in Table 2. In the same way, the reflectance spectra of the films formed on silicon wafers were measured. The reflectance spectra of the antireflection films in Example 1, Example 4, Example 5, and Example 7 are shown in FIG. 5, FIG. 6, FIG. 7 and FIG. 8, respectively.

### <Observation of Cross-Section of Antireflection Film>

The antireflection film of each Example was cut along a plane perpendicular to the main surface of the substrate, and the cross-section was subjected to a conductive treatment by carbon deposition to prepare a sample. This sample was observed using a field emission scanning electron microscope (FE-SEM) SU8220 manufactured by Hitachi High-Tech Corporation, and a SEM image of the cross-section of the antireflection film of each Example was obtained at 100,000 times magnification. In the SEM image of the cross-section of the antireflection film according to each Example, taken at 100,000 times magnification, a 500 nm square area was determined such that all layers were included in the thickness direction, the fine particles present in the area were determined, and the outline of each fine particle was approximated by a circle. The outlines of the fine particles present in the 500 nm square area were approximated by circles, the fine particles recognizable in at least half the area of the circles were determined, the diameter of those circles was measured, and the measured value was defined as the diameter of each particle. The arithmetic mean of the diameters of all the fine particles in the 500 nm square area was calculated, and the average particle diameter Dₚ of the fine particles included in each layer of the antireflection film according to each Example was obtained.

In addition, in each SEM image of the cross-section of the antireflection film according to Examples 4 to 9, the number N_{M1} of fine particles that are partially embedded in the layer closer to the substrate at the boundary between the layers was determined by identifying particles approximated by circles in a 500 nm square area determined so that all layers are included in the thickness direction. In addition, the area S_{L} of the approximate circle of the particles partially embedded in the layer closer to the substrate at the boundary between layers, and the area S_{M} corresponding to the partially circular portion embedded in the approximate circle were determined, and a ratio S_{M}/S_{L} was obtained.

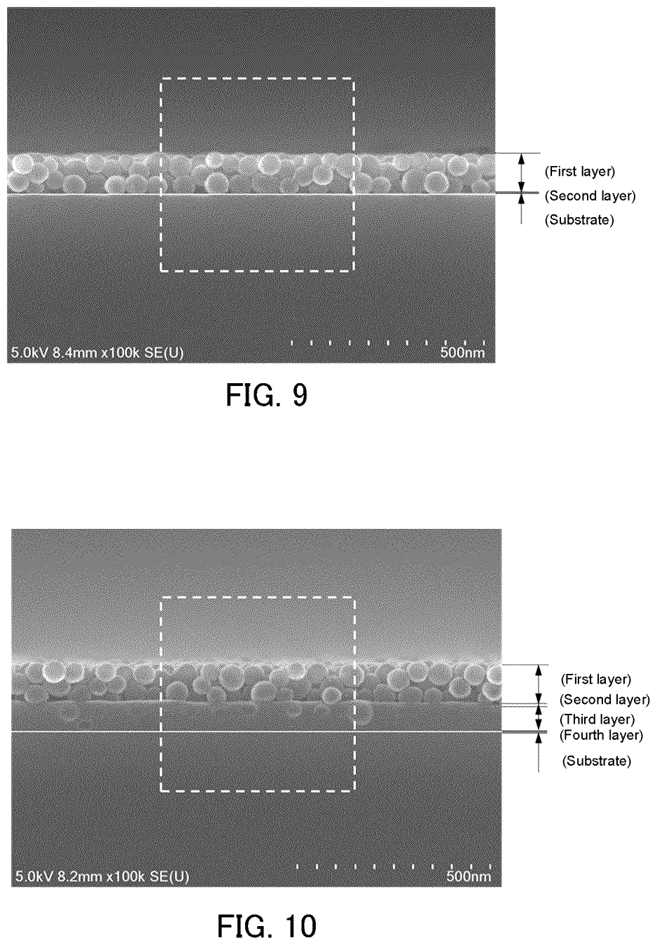

In each of the above SEM images, an approximate straight line corresponding to the surface of the substrate was determined, and a boundary line of each layer was determined so that it would be parallel to the straight line, whereby a thickness of each layer was measured. In the SEM images of the cross-sections of the antireflection films in Examples 1 to 3, the thickness t_{LL} of the entire layer including the first layer and the second layer was measured. In the SEM images of the cross-sections of the antireflection films in Examples 4 and 7, the thickness t_{LL} of the entire layer including the first layer and the second layer and the thickness t_{M3} of the third layer were measured. In the SEM images of the cross-sections of the antireflection films in Examples 5 and 6, the thickness t_{LL} of the entire layer including the first layer and the second layer and the thickness t_{MM} of the layer including the third layer and the fourth layer were measured. In Examples 1 to 3, the first layer and the second layer were disposed in this order toward the substrate. In Examples 4 and 7, the first layer, the second layer, and the third layer were disposed in this order toward the substrate. In Examples 5 and 6, the first layer, the second layer, the third layer, and the fourth layer were disposed in this order toward the substrate. FIG. 9 is a SEM image of the cross-section of the antireflection film according to Example 1. FIG. 10 is a SEM image of the cross-section of the antireflection film according to Example 5. In FIG. 9 and FIG. 10, the area surrounded by the white broken line indicates the area of 500 nm square selected to obtain the average particle diameter Dₚ, the number of fine particles N_{M1}, and the ratio S_{M}/S_{L}.

### <Fitting of Reflection Spectrum>

Parameters such as the refractive index and the thickness of each layer included in each film in each Example were calculated. For this purpose, fitting was performed between the reflection spectrum obtained by measuring the film according to each Example formed on a silicon wafer and the reflection spectrum calculated by simulation, using TFCalc (registered trademark), which is an optical thin film coating characteristic calculation software manufactured by HULINKS Inc. The refractive index and the thickness calculated in this manner can be regarded as the refractive index and the thickness of each layer in the antireflection film according to each Example.

For Examples 1 to 3, the refractive index n_{L1} of the first layer, the refractive index n_{L2} of the second layer, the thickness t_{L1} of the first layer, and the thickness t_{L2} of the second layer were determined. Regarding the thickness t_{L2} of the second layer, it was assumed that the binder included in the second layer was unevenly distributed at the boundary between the second layer and the substrate, and the thickness t_{L2} was assumed to be 2 nm.

For Examples 4 and 7, the refractive index n_{L1} of the first layer, the refractive index n_{L2} of the second layer, the refractive index n_{L3} of the third layer, the thickness t_{L1} of the first layer, the thickness t_{L2} of the second layer, and the thickness t_{M3} of the third layer were obtained. Regarding the thickness t_{L2} of the second layer, it was assumed that the binder included in the second layer was unevenly distributed at the boundary between the second layer and the substrate, and the thickness t_{L2} was assumed to be 2 nm.

For Examples 5, 6, and 9, the refractive index n_{L1} of the first layer, the refractive index n_{L2} of the second layer, the refractive index n_{L3} of the third layer, the refractive index n_{L4} of the fourth layer, the thickness t_{L1} of the first layer, the thickness t_{L2} of the second layer, the thickness t_{M3} of the third layer, and the thickness t_{M4} of the fourth layer, were obtained. The thickness t_{L2} of the second layer was assumed to be 16 nm, which corresponds to the sum of the thickness of 14 nm of the shell of the hollow fine particle included in the third layer and the thickness of 2 nm of the binder unevenly distributed at the boundary between the first layer and the second layer.

### <Adhesion Test>

Adhesion of the antireflection films according to Examples was tested using requirements and a method (cross-cut peel test) in accordance with the Japanese Industrial Standards (JIS) K5600-5-6. Six cut lines were made vertically and horizontally at intervals of 1 mm on the surface of the antireflection film according to each Example, thereby a cut line pattern of 25 square grids with each side measuring 1 mm in a plan view was formed. The substrate with the antireflection film was placed on a flat glass table, and a pressure-sensitive adhesive tape was stuck to the antireflection film at a surface pressure of 3.3 N/cm². The pressure-sensitive adhesive tape was then peeled off from the surface of the antireflection film at a 60° angle while lifting the edge of the tape over a period of one second. The pressure-sensitive adhesive tape used was Clean Room Cellotape CRCT-18 manufactured by Nichiban Co., Ltd. Cellotape is a registered trademark. The adhesive tape was stuck and peeled twice over the entire surface of the antireflection film with the cut line pattern formed thereon. The adhesion of each antireflection film was evaluated according to the following evaluation criteria. The results are shown in Table 2. As shown in Table 2, the antireflection films according to Examples 1 to 8 had high adhesion compared to the antireflection film according to Example 9.
A: Of 25 squares, the number of peeled squares is 0.
B: Of 25 squares, the number of peeled squares is more than or equal to 0 and less than 5%.
C: Of 25 squares, the number of peeled squares is 5% or more and less than 15%.
D: Of 25 squares, the number of peeled squares is 15% or more and less than 35%.
E: Of 25 squares, the number of peeled squares is 35% or more.

TABLE 1

Liquid composition (first layer and second layer)

Fine particles

| | | | | | | | Ratio of mass of fine |
|---|---|---|---|---|---|---|---|
| | | | | | | | particles to mass of |
| | Liquid | Alkoxysilane molar ratio | | | | | solid content of liquid |
| | composition | TEOS | MTES | n-PTMS | Type | Structure | composition |
| Example 1 | B1 | 7 | 3 | 0 | Silicon oxide | Hollow | 99.0% |
| Example 2 | B2 | 5 | 5 | 0 | Silicon oxide | Hollow | 95.0% |
| Example 3 | B4 | 1 | 9 | 0 | Silicon oxide | Hollow | 90.0% |
| Example 4 | B1 | 7 | 3 | 0 | Silicon oxide | Hollow | 99.0% |
| Example 5 | B2 | 5 | 5 | 0 | Silicon oxide | Hollow | 95.0% |
| Example 6 | B5 | 3 | 0 | 7 | Silicon oxide | Hollow | 95.0% |
| Example 7 | B1 | 7 | 3 | 0 | Silicon oxide | Hollow | 99.0% |
| Example 8 | B3 | 3 | 7 | 0 | Silicon oxide | Hollow | 90.0% |
| Example 9 | B10 | 7 | 3 | 0 | Silicon oxide | Hollow | 99.8% |

| | Liquid composition (third layer and fourth layer) | | | | | | |
|---|---|---|---|---|---|---|---|
| | | | | | Fine particles | | |
| | | | | | | | Ratio of mass of fine |
| | | | | | | | particles to mass of |
| | Liquid | Alkoxysilane molar ratio | | | | | solid content of liquid |
| | composition | TEOS | MTES | n-PTMS | Type | Structure | composition |
| Example 1 | — | — | — | — | — | — | — |
| Example 2 | — | — | — | — | — | — | — |
| Example 3 | — | — | — | — | — | — | — |
| Example 4 | B6 | 7 | 3 | 0 | — | — | — |
| Example 5 | B8 | 7 | 3 | 0 | Silicon oxide | Hollow | 10.0% |
| Example 6 | B7 | 7 | 3 | 0 | Silicon oxide | Hollow | 13.1% |
| Example 7 | B9 | 7 | 3 | 0 | Titanium oxide | Solid | 54.2% |
| Example 8 | — | — | — | — | — | — | — |
| Example 9 | B8 | 3 | 7 | 0 | Silicon oxide | Hollow | 10.0% |

TABLE 2

| | | First layer | | Second layer | | Average particle diameter of |
|---|---|---|---|---|---|---|
| | Reflectance | Refractive | Thickness | Refractive | Thickness | first hollow fine particle Dₚ |
| | (D line) [%] | index n_{L1} | t_{L1} [nm] | index n_{L2} | t_{L2}[nm] | [nm] |
| Example 1 | 0.12 | 1.15 | 115 | 1.44 | 2 | 61 |
| Example 2 | 0.12 | 1.19 | 111 | 1.44 | 2 | 61 |
| Example 3 | 0.13 | 1.21 | 117 | 1.44 | 2 | 60 |
| Example 4 | 0.10 | 1.15 | 123 | 1.44 | 2 | 61 |
| Example 5 | 0.11 | 1.21 | 129 | 1.44 | 16 | 59 |
| Example 6 | 0.12 | 1.19 | 115 | 1.44 | 16 | 60 |
| Example 7 | 0.11 | 1.15 | 120 | 1.44 | 2 | 61 |
| Example 8 | 0.21 | 1.24 | 121 | 1.44 | 2 | 59 |
| Example 9 | 0.12 | 1.14 | 121 | 1.44 | 16 | 60 |

| | Third layer | | Fourth layer | | | | | |
|---|---|---|---|---|---|---|---|---|
| | Refractive | Thickness | Refractive | Thickness | | S_{M}/S_{L} | λ_{range/1.0} | Adhesion |
| | index n_{L3} | t_{M3} [nm] | index n_{L4} | t_{M4} [nm] | N_{M1} | [%] | [nm] | test |
| Example 1 | — | — | — | — | — | — | 400 | A |
| Example 2 | — | — | — | — | — | — | 405 | A |
| Example 3 | — | — | — | — | — | — | 399 | A |
| Example 4 | 1.42 | 79 | — | — | 4 | 19 | 635 | A |
| Example 5 | 1.40 | 53 | 1.42 | 14 | 2 | 11 | 643 | A |
| Example 6 | 1.39 | 55 | 1.42 | 14 | 3 | 14 | 625 | A |
| Example 7 | 1.634 | 161 | — | — | 2 | 12 | 380 | A |
| Example 8 | 1.46 | 103 | — | — | — | — | 456 | A |
| Example 9 | 1.40 | 61 | 1.42 | 14 | 2 | 10 | 633 | C |

1. An antireflection film to be provided on a substrate,
the antireflection film comprising: in sequence, a first layer; a second layer; and the substrate
the first layer having a refractive index n_{L1} of 1.10 to 1.35 and a thickness of 80 nm to 150 nm, and
the second layer having a refractive index n_{L2} of 1.30 to 1.55 and a thickness of 25 nm or less.

2. The antireflection film according to claim 1, wherein
a requirement n_{L1}<n_{L2} is satisfied.

3. The antireflection film according to claim 1, wherein
the antireflection film comprises first hollow fine particles and a first binder binding the first hollow fine particles, and a content of the first hollow fine particles in the antireflection film is 80% to 99.5% by mass.

4. (canceled)

5. The antireflection film according to claim 3, wherein
the first binder comprises at least one selected from the group consisting of an alkoxysilane, a hydrolysate of an alkoxysilane, and a polymer of a hydrolysate of an alkoxysilane.

6. The antireflection film according to claim 1, wherein
a minimum reflectance in a wavelength range of 400 nm to 800 nm is 0.5% or less.

7. The antireflection film according to claim 1, wherein
a range λ_{range/1.0} in which a reflectance is 1% or less in a wavelength range of 300 nm to 1200 nm is 250 nm or more.

8. The antireflection film according to claim 1, the antireflection film further comprising a third layer between the second layer and the substrate, wherein
the third layer has a refractive index n_{L3} of 1.30 to 2.25 and a thickness of 60 nm to 200 nm.

9. The antireflection film according to claim 8, wherein
a requirement n_{L1}<n_{L3}<n_{L2} is satisfied.

10. The antireflection film according to claim 8, wherein
the first layer and the second layer form a first multilayer structure, the first multilayer structure includes first hollow fine particles and a first binder binding the first hollow fine particles, and
the third layer includes at least a second binder.

11. The antireflection film according to claim 8, the antireflection film further comprising
a fourth layer between the third layer and the substrate, wherein
the fourth layer has a refractive index n_{L4} of 1.30 to 1.55 and a thickness of 25 nm or less.

12. The antireflection film according to claim 11, wherein
the first layer and the second layer form a first multilayer structure,
the third layer and the fourth layer form a second multilayer structure,
the first multilayer structure includes first hollow fine particles and a first binder binding the first hollow fine particles, and
the second multilayer structure includes second hollow fine particles and a second binder binding the second hollow fine particles.

13. (canceled)

14. A liquid composition capable of being cured into the antireflection film according to claim 1, the liquid composition comprising:
first hollow fine particles; and
at least one selected from the group consisting of an alkoxysilane and a hydrolysate of an alkoxysilane, wherein
a mass ratio of the first hollow fine particles to a solid content of the liquid composition is 80% to 99.5%.

15. The liquid composition according to claim 14, wherein
the alkoxysilane includes a tetrafunctional alkoxysilane and a trifunctional alkoxysilane, and
a molar ratio of the tetrafunctional alkoxysilane to the trifunctional alkoxysilane is 1/9 to 9.

16-18. (canceled)

19. A method for manufacturing an antireflection film, comprising:
preparing a first liquid composition including first hollow fine particles and at least one selected from the group consisting of an alkoxysilane and a hydrolysate of an alkoxysilane,
a mass ratio of the first hollow fine particles to the first liquid composition being 80% to 99.5%;
and one selected from the group consisting of following (a), (b) and (c):
(a) coating the first liquid composition on a surface of a substrate; solidifying the coating; and forming a first layer and a second layer in this order from the surface of the antireflection film,
wherein the second layer includes a part of the outer shell of the first hollow fine particles and a part of the hydrolyzate of alkoxysilane:
(b) providing a third layer including a dielectric on a surface of a substrate; coating the first liquid composition on a surface of the third layer; solidifying the coating; and forming a first layer, a second layer and a third layer in this order from the surface of the antireflection film, and
wherein the second layer includes a part of the outer shell of the first hollow fine particles and a part of the hydrolyzate of alkoxysilane:
(c) coating of a second liquid composition on a surface of a substrate, the second liquid composition including second fine particles that includes an oxide and at least one selected from the group consisting of alkoxysilane and hydrolyzate of alkoxysilane; solidifying the coating of the second liquid composition; and
coating the first liquid composition on the surface of the solidified coating of the second liquid composition; solidifying the coating of the first liquid composition; and forming a first layer, a second layer, a third layer and a fourth layer in order from the surface of the anti-reflection coating,
wherein the second layer includes a part of the outer shell of the first hollow fine particles, a part of the hydrolyzate of alkoxysilane and a part of the second fine particles.

20. The method according to claim 19, wherein
the first layer has a refractive index n_{L1} of 1.10 to 1.35 and a thickness of 80 nm to 150 nm,
the second layer has a refractive index n_{L2} of 1.30 to 1.55 and a thickness of 25 nm or less, and
a requirement n_{L1}<n_{L2} is satisfied.

21. The method according to claim 19, wherein
the antireflection film allows a reflected light from the antireflection film to have a reflection spectrum in which a minimum reflectance in a wavelength range of 400 nm to 800 nm is 0.5% or less, and a range λ_{range/1.0} in which a reflectance of 1% or less in a wavelength range of 300 nm to 1200 nm is 250 nm or more.

22. (canceled)

23. The method according to claim 19, the method comprising (b),
wherein
the first layer has a refractive index n_{L1} of 1.10 to 1.35 and a thickness of 80 nm to 150 nm,
the second layer has a refractive index n_{L2} of 1.30 to 1.55 and a thickness of 25 nm or less,
the third layer has a refractive index of n_{L3} of 1.30 to 2.25 and a thickness of 60 nm to 200 nm, and
a requirement n_{L1}<n_{L2} is satisfied.

24. The method according to claim 23, wherein
the third layer includes the following layers (i) and/or (ii):
(i) a layer including a dielectric film including one or at least two oxides selected from the group consisting of SiO₂, MgF₂, TiO₂, Ta₂O₃, AlF₃, CaF₂, Al₂O₃, ZrO₂, WO₃, CeO₂, indium tin oxide, and antimony tin oxide; and
(ii) a layer including: fine particles of an oxide composed of one or at least two materials selected from the group consisting of SiO₂, TiO₂, ZrO₂, CeO₂, indium tin oxide, and antimony tin oxide; and a binder for binding the fine particles of the oxide.

25. (canceled)

26. The method according to claim 19, the method comprising (c), wherein
the first layer has a refractive index n_{L1} of 1.10 to 1.35 and a thickness of 80 nm to 150 nm,
the second layer has a refractive index n_{L2} of 1.30 to 1.55 and a thickness of 25 nm or less,
the third layer has a refractive index n_{L3} of 1.30 to 2.25 and a thickness of 60 nm to 200 nm,
the fourth layer has a refractive index n_{L4} of 1.30 to 1.55 and a thickness of 25 nm or less, and
requirements n_{L1}<n_{L2} and n_{L3}<n_{L4} are satisfied.

27. The method according to claim 9, the method comprising (c), wherein
a mass ratio of the second fine particles to the second liquid composition is 5% to 75%.
